(19) United States
(12) Patent Application Publication
(10) Pub. No.: US 2024/0276413 A1
(43) Pub. Date: Aug. 15, 2024

(54) METHOD AND DEVICE USED IN COMMUNICATION NODE FOR WIRELESS COMMUNICATION

(71) Applicants: Qiaoling YU, Shanghai (CN); Xiaobo ZHANG, Shanghai (CN)

(72) Inventors: Qiaoling YU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/432,088

(22) Filed: Feb. 5, 2024

(30) Foreign Application Priority Data
Feb. 12, 2023 (CN) 202310104595.4
Feb. 27, 2023 (CN) 202310179131.X

(51) Int. Cl. H04W 56/00; H04W 74/00; H04W 74/0833; H04W 80/02

(52) U.S. Cl. CPC H04W 56/0045; H04W 74/006; H04W 74/0833; H04W 80/02

(57) ABSTRACT

The present application discloses a method and a device in a communication node for wireless communications. The communication node receives a first signaling, the first signaling comprising at least one indication field and at least one target field; the first signaling is a signaling at a protocol layer below RRC sublayer; each indication field of the at least one indication field indicates whether a corresponding target field is used for a Timing Advance (TA). The present application proposes to enable the first signaling to adaptively indicate the timing advance by through of the at least one indication field, avoiding the introduction of multiple signaling formats and reducing the impact on the standard.

### CROSS REFERENCE TO RELATED APPLICATIONS

This application claims the priority benefit of Chinese Patent Application No. 202310179131.X, filed on Feb. 27, 2023, and claims the priority benefit of Chinese Patent Application No. 202310104595.4, filed on Feb. 12, 2023, the full disclosure of which is incorporated herein by reference.

### BACKGROUND

### Technical Field

The present application relates to transmission methods and devices in wireless communication systems, and in particular to a transmission method and a device for random access.

### Related Art

At the 3rd Generation Partner Project (3GPP) Radio Access Network (RAN) #94e conference, it was decided to study Layer 1/Layer 2 triggered mobility (L1/L2 Triggered Mobility, LTM) in the Work Item (WI) of “Further NR mobility enhancements”, including the management of Timing Advance (TA) for candidate cells. The 3GPP RAN94e meeting decided on studies of two-TA based uplink multiple Transmit/Receive Point (multi-TRP/m-TRP) operations in the Work Item (WI) of “MIMO Evolution for Downlink and Uplink”.

The Random Access (RA) procedure plays an important role in wireless communications, for it can be used for Initial Access, establishing time alignment, Beam Failure Recovery (BFR), Listen Before Talk (LBT), System Information (SI) Request and so on. Therefore, obtaining the timing advance of a candidate cell for LTM through a random access procedure or, alternatively, obtaining two TAs for multi-TRP/m-TRP through a random access procedure is a feasible technical approach.

### SUMMARY

In existing protocols, the UE (i.e., User Equipment) obtains timing advances by receiving signalings from protocol layers below a Radio Resource Control (RRC) sublayer that include field(s) used for timing advance, such as Timing Advance Command Medium Access Control (MAC) Control Element (CE) or Absolute Timing Advance Command MAC CE or MAC Random Access Response (RAR) or fallbackRAR or successRAR, etc. As long as the UE receives these signalings from protocol layers below the RRC sublayer, there must exist a field that is used for the timing advance. Existing signalings at the protocol layers below an RRC sublayer supports only one timing advance, and it is difficult to adaptively indicate the timing advance. Therefore, how signaling at the protocol layer below the RRC sublayer adaptively indicates timing advance needs to be enhanced.

To address the above problem, the present application provides a solution for random access. The description above only took NR system as an example, but this application is equally applicable to scenarios with the Long-Term Evolution (LTE) system, where similar technical effects can be achieved; furthermore, although the present application provides specific implementations for LTM only, it can also be used for scenarios like multi-TRP/m-TRP, to achieve technical effects similar to LTM. Further, though originally intended for the Uu air interface, the present application also applies to the PC5 interface, to achieve technical effects similar to those at the Uu air interface. Further, although this application was originally intended for terminal-base station scenarios, it is equally applicable to Vehicle-to-Everything (V2X), terminal-relay communications, as well as relay-base station communication scenarios, to achieve technical effects similar to those in terminal-base station scenarios. Further, although this application was originally intended for terminal-base station scenarios, it is equally applicable to Integrated Access and Backhaul (IAB) communications, to achieve technical effects similar to those in terminal-base station scenarios. Further, although this application was originally intended for Terrestrial Network (TN) scenarios, it is equally applicable to Non-Terrestrial Network (NTN) communication scenarios, to achieve technical effects similar to those in TN scenarios. Additionally, the adoption of a unified solution for various scenarios contributes to the reduction of hardcore complexity and costs.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

The present application provides a method in a first node for wireless communications, comprising:
receiving a first signaling, the first signaling comprising at least one indication field and at least one target field;
herein, the first signaling is a signaling at a protocol layer below RRC sublayer; each indication field of the at least one indication field indicates whether a corresponding target field is used for a TA.

In one embodiment, a problem to be solved in the present application includes: how signaling at protocol layer below the RRC sublayer indicates a Timing Advance self-adaptively.

In one embodiment, the characteristics of the above method include: the first signaling comprising at least one indication field and at least one target field.

In one embodiment, the characteristics of the above method include: each indication field of the at least one indication field indicating whether a corresponding target field is used for a TA.

In one embodiment, the characteristics of the above method include: indicating whether a corresponding target field is used for a TA or not via each indication field of the at least one indication field.

In one embodiment, an advantage of the above method includes: enabling the first signaling to self-adaptively indicate a timing advance via the at least one indication field.

In one embodiment, an advantage of the above method includes: avoiding the introduction of multiple signaling formats.

In one embodiment, an advantage of the above method includes: reducing the impact on standards.

According to one aspect of the present application, characterized in comprising:
receiving a first RRC message before the action of receiving a first signaling, the first RRC message comprising configuration information for at least one candidate cell; and applying configuration information for a first cell as a response to the first signaling being received;
herein, the at least one candidate cell is configured for at least one serving cell of the first node; the first cell is a candidate cell of the at least one candidate cell; the first signaling is used to indicate the first cell.

According to one aspect of the present application, characterized in comprising:
after the action of receiving the first RRC message and before the action of receiving a first signaling, transmitting a first measurement report;
herein, the first measurement report is a signaling at a protocol layer below RRC sublayer.

According to one aspect of the present application, characterized in comprising:
transmitting at least first signal before the action of receiving a first signaling;
herein, each signal of the at least first signal is a physical layer signal.

According to one aspect of the present application, characterized in comprising:
receiving a first DCI (i.e., Downlink Control Information), the first DCI indicating the at least first signal;
herein, each signal of the at least first signal is a Physical Random Access Channel (PRACH) signal; the first DCI is used to trigger a random access procedure which the at least first signal is a part of.

According to one aspect of the present application, characterized in that as a response to the action of receiving a first signaling, when each target field in the first signaling indicates a TA, it is determined that a random access response is received successfully; when at least one target field in the first signaling does not indicate a TA, continue listening over the random access response.

According to one aspect of the present application, characterized in comprising:
as a response to the action of receiving a first signaling, determining that a random access procedure is successfully completed.

According to one aspect of the present application, characterized in comprising:
processing at least one of the at least one target field as a response to the action of receiving a first signaling;
herein, the at least one of the at least one target field indicates a TA.

The present application provides a method in a second node for wireless communications, comprising:
transmitting a first signaling, the first signaling comprising at least one indication field and at least one target field;
herein, the first signaling is a signaling at a protocol layer below RRC sublayer; each indication field of the at least one indication field indicates whether a corresponding target field is used for a TA.

According to one aspect of the present application, characterized in comprising:
transmitting a first RRC message before the action of transmitting a first signaling, the first RRC message comprising configuration information for at least one candidate cell;
herein, as a response to the first signaling being received by a receiver of the first signaling, configuration information for a first cell is applied by the receiver of the first signaling; the at least one candidate cell is configured for at least one serving cell of the first node; the first cell is a candidate cell of the at least one candidate cell; the first signaling is used to indicate the first cell.

According to one aspect of the present application, characterized in comprising:
after the action of transmitting the first RRC message and before the action of transmitting a first signaling, receiving a first measurement report;
herein, the first measurement report is a signaling at a protocol layer below RRC sublayer.

According to one aspect of the present application, characterized in comprising:
receiving at least first signal before the action of transmitting a first signaling;
herein, each signal of the at least first signal is a physical layer signal.

According to one aspect of the present application, characterized in comprising:
transmitting a first DCI, the first DCI indicating the at least first signal;
herein, each signal of the at least first signal is a PRACH signal; the first DCI is used to trigger a random access procedure which the at least first signal is a part of.

According to one aspect of the present application, characterized in that as a response to the first signaling being received, when each target field in the first signaling indicates a TA, a random access response is determined to have been received successfully; when at least one target field in the first signaling does not indicate a TA, the random access response continues to be listened over.

According to one aspect of the present application, characterized in that as a response to the first signaling being received, a random access procedure is determined to have been successfully completed.

According to one aspect of the present application, characterized in that as a response to the action of receiving a first signaling, at least one of the at least one target field is processed; the at least one of the at least one target field indicates a TA.

The present application provides a first node for wireless communications, comprising:
a first processor, receiving a first signaling, the first signaling comprising at least one indication field and at least one target field;
herein, the first signaling is a signaling at a protocol layer below RRC sublayer; each indication field of the at least one indication field indicates whether a corresponding target field is used for a TA.

The present application provides a second node for wireless communications, comprising:
a second processor, transmitting a first signaling, the first signaling comprising at least one indication field and at least one target field;
herein, the first signaling is a signaling at a protocol layer below RRC sublayer; each indication field of the at least one indication field indicates whether a corresponding target field is used for a TA.

In one embodiment, compared with the prior art, the present application is advantageous in the following aspects:
enabling the first signaling to self-adaptively indicate a timing advance via the at least one indication field;
avoiding the introduction of multiple signaling formats;
reducing the impact on the standards.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first signaling according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to another embodiment of the present application.

FIG. 7 illustrates a flowchart of response to a first signaling according to one embodiment of the present application.

FIG. 8 illustrates a flowchart of response to a first signaling according to another embodiment of the present application.

FIG. 9 illustrates a flowchart of response to a first signaling according to yet another embodiment of the present application.

FIG. 10 illustrates a schematic diagram of the structure of a first signaling according to the first embodiment of the present application.

FIG. 11 illustrates a schematic diagram of the structure of a first signaling according to the second embodiment of the present application.

FIG. 12 illustrates a schematic diagram of the structure of a first signaling according to the third embodiment of the present application.

FIG. 13 illustrates a schematic diagram of the structure of a first signaling according to the fourth embodiment of the present application.

FIG. 14 illustrates a schematic diagram of the structure of a first signaling according to the fifth embodiment of the present application.

FIG. 15 illustrates a structure block diagram of a processing device used in a first node according to one embodiment of the present application.

FIG. 16 illustrates a structure block diagram of a processing device used in a second node according to one embodiment of the present application.

FIG. 17 illustrates a schematic diagram of the structure of a first signaling according to the sixth embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

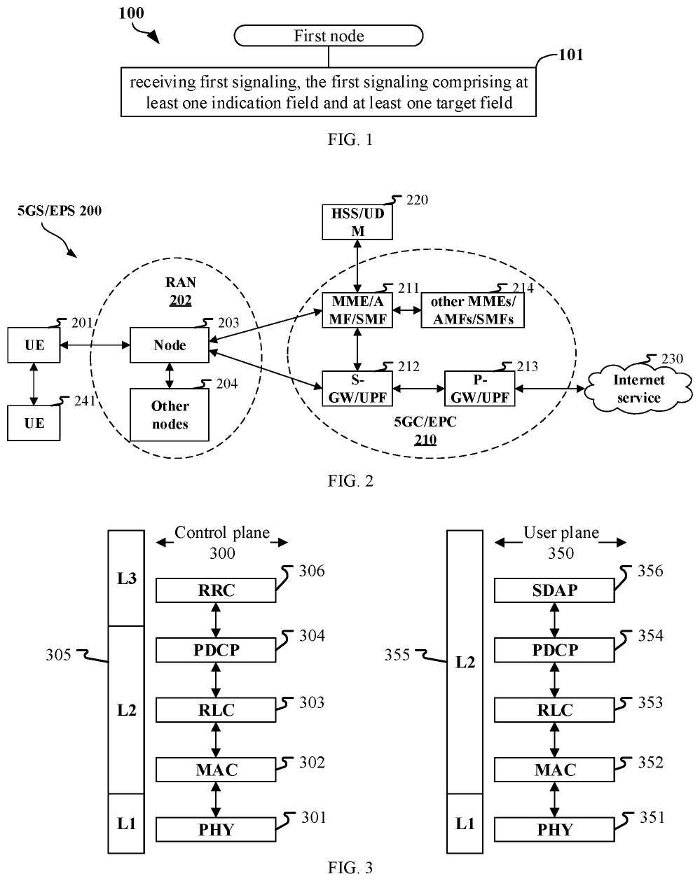

Embodiment 1 illustrates a flowchart of transmission of a first signaling according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101, the first signaling comprising at least one indication field and at least one target field; herein, the first signaling is a signaling at a protocol layer below RRC sublayer; each indication field of the at least one indication field indicates whether a corresponding target field is used for a TA.

In one embodiment, a Random Access procedure is ongoing when the first signaling is received.

In one embodiment, the first signaling is a random access response (RAR).

In one embodiment, any random access procedure isn't ongoing when the first signaling is received.

In one embodiment, the random access procedure does not refer to the random access procedure in section 5.1 of TS 38.321.

In one embodiment, the random access procedure is not a conventional random access procedure.

In one embodiment, the random access procedure is an enhanced random access procedure.

In one embodiment, the random access procedure is a special random access procedure.

In one embodiment, the random access procedure is a procedure for establishing time alignment of a first cell.

In one embodiment, the random access procedure is a procedure triggered by a PDCCH order.

In one embodiment, the random access procedure includes the action of transmitting a first Preamble in the first cell.

In one embodiment, the random access procedure is a timing request procedure.

In one embodiment, the random access procedure is a procedure of requesting uplink transmission timing.

In one embodiment, the random access procedure is a timing advance procedure.

In one embodiment, the protocol layer below the RRC sublayer is a MAC sublayer.

In one subembodiment, a DCI used to schedule the first signaling is identified by a Cell Radio Network Temporary Identifier (C-RNTI) of the first node.

In one subembodiment, a DCI used to schedule the first signaling is identified by a Random Access (RA)-RNTI.

In one subembodiment, a DCI used to schedule the first signaling is identified by a Message B RNTI (MSGB-RNTI).

In one subembodiment, the first signaling does not belong to multiple MAC subPDUs.

In one subembodiment, the first signaling belongs to a same MAC subPDU.

In one subembodiment, the first signaling comprises a MAC subheader.

In one subembodiment, the first signaling is a MAC subPDU.

In one subembodiment, the first signaling does not comprise a MAC subheader.

In one subembodiment, the first signaling is a MAC CE.

In one subembodiment, the first signaling is identified by a Logical Channel ID (LCID), the LCID being an integer no less than 35 and no greater than 46.

In one subembodiment, the first signaling is identified by an extended Logical Channel ID (eLCID), the eLCID being an integer no less than 220 and no greater than 226.

In one subembodiment, the first signaling is identified by an eLCID, the eLCID being 252.

In one subembodiment, the first signaling is a MAC RAR.

In one embodiment, the protocol layer below the RRC sublayer is a physical layer.

In one subembodiment, the first signaling is a DCI.

In one subembodiment, the first signaling is a DCI format 1_0.

In one subembodiment, the first signaling is a DCI format 1_1.

In one subembodiment, the first signaling is identified by a C-RNTI of the first node.

In one subembodiment, the first signaling is identified by a RA-RNTI.

In one subembodiment, the first signaling is identified by a MSGB-RNTI.

In one embodiment, the number of indication field(s) in the first signaling is unequal to that of target field(s) in the first signaling.

In one embodiment, the number of indication field(s) in the first signaling is equal to that of target field(s) in the first signaling.

In one embodiment, the first signaling comprises 1 indication field and 2 target fields.

In one embodiment, the first signaling comprises 2 indication fields and 4 target fields.

In one embodiment, the first signaling comprises 1 indication field and 1 target field.

In one embodiment, the first signaling comprises 2 indication fields and 2 target fields.

In one embodiment, the first signaling comprises 8 indication fields and 8 target fields.

In one embodiment, the at least one indication field corresponds/respectively correspond to the at least one target field.

In one embodiment, an indication field of the at least one indication field corresponds to a target field of the at least one target field.

In one embodiment, any two indication fields of the at least one indication field correspond to different target fields of the at least one target field.

In one embodiment, there includes at least one bit between any two indication fields of the at least one indication field.

In one embodiment, there does not include any bit between any two indication fields of the at least one indication field.

In one embodiment, each of the at least one indication field occupies 1 bit.

In one embodiment, the at least one indication field is a bitmap.

In one embodiment, each of the at least one indication field occupies multiple consecutive bits.

In one embodiment, each of the at least one target field occupies multiple consecutive bits.

In one embodiment, each of the at least one target field occupies 11 bits.

In one embodiment, each of the at least one target field occupies 12 bits.

In one embodiment, each of the at least one target field occupies 13 bits.

In one embodiment, each of the at least one indication field and a corresponding target field correspond to a TA set.

In one embodiment, each of the at least one indication field and a corresponding target field are associated with a TA set.

In one embodiment, each of the at least one indication field and a corresponding target field are for a TA set.

In one embodiment, a position of each of the at least one indication field indicates a TA set.

In one embodiment, a position of each of the at least one indication field is indexed to a TA set.

In one embodiment, an index of each of the at least one indication field in a bitmap indicates a TA set.

In one embodiment, a value of each of the at least one indication field is indexed to a TA set.

In one embodiment, a value of each of the at least one indication field is an index of a TA set.

In one embodiment, each of the at least one indication field is set to an index of a TA set.

In one embodiment, any two indication fields of the at least one indication field correspond to different TA sets.

In one embodiment, a timing advance (TA) set is pre-configured.

In one embodiment, a timing advance (TA) set is configured by RRC signaling.

In one embodiment, a timing advance (TA) set comprises at least one cell.

In one embodiment, a timing advance (TA) set is a cell group.

In one embodiment, a timing advance (TA) set is a cell group to which candidate cells belong.

In one embodiment, a timing advance (TA) set is a TAG.

In one embodiment, a timing advance (TA) set is a TAG to which candidate cells belong.

In one embodiment, the TAG refers to Timing Advance Group.

In one embodiment, the TAG refers to Time Alignment Group.

In one embodiment, a timing advance (TA) set is a cell.

In one embodiment, a timing advance (TA) set is a candidate cell.

In one embodiment, a timing advance (TA) set comprises at least one TRP.

In one embodiment, a timing advance (TA) set is a TRP.

In one embodiment, a timing advance (TA) set comprises at least one radio resource.

In one embodiment, a timing advance (TA) set comprises at least one reference signal resource.

In one subembodiment, reference signal resources comprised by a TA set are configured via an RRC message.

In one subembodiment, reference signal resources comprised by a TA set are a reference signal resource set.

In one subembodiment, any two TA sets do not include the same reference signal resource.

In one subembodiment, any two TA sets include at least one different reference signal resource.

In one subembodiment, any reference signal resource comprised by a TA set is an SSB.

In one subembodiment, the SSB is a Synchronization Signal Block.

In one subembodiment, the SSB is a SS/PBCH Block.

In one subembodiment, any reference signal resource comprised by a TA set is a Channel State Information-Reference Signal (CSI-RS).

In one subembodiment, any reference signal resource comprised by a TA set is an SSB or a CSI-RS.

In one embodiment, the timing advance refers to: T_{A}.

In one embodiment, the timing advance refers to: an index value T_{A} used to control the amount of timing adjustment a MAC entity has to apply.

In one embodiment, the timing advance is an index value.

In one embodiment, at least one field in the first signaling indicates a timing advance, and, any one of the at least one target field does not indicate a timing advance.

In one embodiment, only one field in the first signaling indicates a timing advance, and, any one of the at least one target field does not indicate a timing advance.

In one embodiment, multiple fields in the first signaling indicate a timing advance, and, any one of the at least one target field does not indicate a timing advance.

In one embodiment, the phrase that each indication field of the at least one indication field indicates whether a corresponding target field is used for a TA includes: if one indication field of the at least one indication field is set to a first value, the indication field of the at least one indication field indicates that a corresponding target field is used for a TA; if one indication field of the at least one indication field is set to a second value, the indication field of the at least one indication field does not indicate that a corresponding target field is used for a TA; the first value is different from the second value.

In one embodiment, the phrase that each indication field of the at least one indication field indicates whether a corresponding target field is used for a TA includes: each indication field of the at least one indication field indicates whether a corresponding target field is used to determine a TA.

In one embodiment, the phrase that each indication field of the at least one indication field indicates whether a corresponding target field is used for a TA includes: each indication field of the at least one indication field indicates whether a corresponding target field is used to calculate a TA.

In one embodiment, the phrase that each indication field of the at least one indication field indicates whether a corresponding target field is used for a TA includes: each indication field of the at least one indication field indicates whether a corresponding target field is used to indicate a TA.

In one embodiment, the phrase that each indication field of the at least one indication field indicates whether a corresponding target field is used for a TA includes: each indication field of the at least one indication field indicates whether a corresponding target field is used to determine a TA set.

In one embodiment, the phrase that each indication field of the at least one indication field indicates whether a corresponding target field is used for a TA includes: each indication field of the at least one indication field indicates whether a corresponding target field is used to indicate a TA set.

In one embodiment, the phrase that each indication field of the at least one indication field indicates whether a corresponding target field is used for a TA can be replaced with: each indication field of the at least one indication field indicates whether a corresponding target field is related to timing advance.

In one embodiment, the phrase that each indication field of the at least one indication field indicates whether a corresponding target field is related to timing advance includes: if one indication field of the at least one indication field is set to a first value, the indication field of the at least one indication field indicates that a corresponding target field is related to timing advance; if one indication field of the at least one indication field is set to a second value, the indication field of the at least one indication field does not indicate that a corresponding target field is related to timing advance; the first value is different from the second value.

In one subembodiment, if one indication field of the at least one indication field is set to the first value, a corresponding target field of the indication field of the at least one indication field is related to timing advance.

In one subembodiment, if one indication field of the at least one indication field is set to the first value, the value of a corresponding target field of the indication field of the at least one indication field is related to timing advance.

In one subembodiment, if one indication field of the at least one indication field is set to the second value, a corresponding target field of the indication field of the at least one indication field is unrelated to timing advance.

In one embodiment, the phrase that each indication field of the at least one indication field indicates whether a corresponding target field is used for a TA can be replaced with: each indication field of the at least one indication field indicates whether a corresponding target field is used to indicate a TA.

In one embodiment, the phrase that each indication field of the at least one indication field indicates whether a corresponding target field is used to indicate a TA includes: if one indication field of the at least one indication field is set to a first value, the indication field of the at least one indication field indicates that a corresponding target field is used to indicate a TA; if one indication field of the at least one indication field is set to a second value, the indication field of the at least one indication field does not indicate that a corresponding target field is used to indicate a TA; the first value is different from the second value.

In one subembodiment, if one indication field of the at least one indication field is set to a first value, a corresponding target field of the indication field of the at least one indication field is set to a TA.

In one subembodiment, if one indication field of the at least one indication field is set to a first value, the value of a corresponding target field of the indication field of the at least one indication field is a TA.

In one subembodiment, if one indication field of the at least one indication field is set to a second value, a corresponding target field of the indication field of the at least one indication field is not used to indicate a TA.

In one subembodiment, any field other than the at least one target field in the first signaling is not used to indicate a timing advance.

In one subembodiment, at least one field other than the at least one target field in the first signaling is used to indicate a timing advance.

In one subembodiment, only one field other than the at least one target field in the first signaling is used to indicate a timing advance.

In one subembodiment, multiple fields other than the at least one target field in the first signaling are used to indicate a timing advance.

In one embodiment, the phrase that each indication field of the at least one indication field indicates whether a corresponding target field is used for a TA can be replaced with: each indication field of the at least one indication field indicates whether a corresponding target field is used to indicate a TA set.

In one embodiment, the phrase that each indication field of the at least one indication field indicates whether a corresponding target field is used to indicate a TA set includes: if one indication field of the at least one indication field is set to a first value, the indication field of the at least one indication field indicates that a corresponding target field is used to indicate a TA set; if one indication field of the at least one indication field is set to a second value, the indication field of the at least one indication field does not indicate that a corresponding target field is used to indicate a TA set; the first value is different from the second value.

In one subembodiment, if one indication field of the at least one indication field is set to the first value, a corresponding target field of the indication field of the at least one indication field is set to an index of a TA set.

In one subembodiment, if one indication field of the at least one indication field is set to the first value, the value of a corresponding target field of the indication field of the at least one indication field is an index of a TA set.

In one subembodiment, if one indication field of the at least one indication field is set to the second value, a corresponding target field of the indication field of the at least one indication field does not indicate a TA set.

In one subembodiment, the first signaling comprises at least one field that indicates the timing advance.

In one subembodiment, the first signaling comprises at least one Timing Advance Command field that indicates the timing advance.

In one subembodiment, the number of fields indicating timing advance in the first signaling is equal to the number of indication fields in the first signaling.

In one subembodiment, the number of fields indicating timing advance in the first signaling is unequal to the number of indication fields in the first signaling.

In one subembodiment, the number of fields indicating timing advance in the first signaling is greater than the number of indication fields in the first signaling.

In one embodiment, if one indication field of the at least one indication field is set to a second value, a corresponding target field of the indication field of the at least one indication field is reserved.

In one embodiment, if one indication field of the at least one indication field is set to a second value, a corresponding target field of the indication field of the at least one indication field is not reserved.

In one embodiment, if one indication field of the at least one indication field is set to a second value, a corresponding target field of the indication field of the at least one indication field is used to indicate an RNTI.

In one embodiment, if one indication field of the at least one indication field is set to a second value, a corresponding target field of the indication field of the at least one indication field is used to indicate a Temporary C-RNTI.

In one embodiment, if one indication field of the at least one indication field is set to a second value, a corresponding target field of the indication field of the at least one indication field is used to indicate a UL grant.

In one embodiment, if one indication field of the at least one indication field is set to a second value, a corresponding target field of the indication field of the at least one indication field is used to indicate random access resources.

In one embodiment, the first value and the second value are both integers.

In one embodiment, the first value and the second value are both non-negative integers.

In one embodiment, each of the at least one indication field occupies 1 bit.

In one subembodiment, the first value is 1, and the second value is 0.

In one subembodiment, the first value is 0, and the second value is 1.

In one embodiment, each of the at least one indication field occupies multiple bits.

In one embodiment, each of the at least one indication field occupies 2 bits.

In one embodiment, each of the at least one indication field occupies 8 bits.

In one subembodiment, the first value is an integer no less than 0 and no greater than 226, and the second value is 252.

In one subembodiment, the first value is an integer no less than 220 and no greater than 226, and the second value is 252.

In one embodiment, the first value and the second value are pre-configured.

In one embodiment, the first value and the second value are pre-defined.

In one embodiment, the first signaling comprises a first indication field and a first target field; the first indication field indicates whether the first target field is used for timing advance; the first target field is a corresponding target field of the first indication field.

In one embodiment, the first signaling comprises the first target field and the first indication field; the first indication field indicates whether the first target field indicates a TA; the first signaling is a random access response (RAR).

In one subembodiment, the first signaling occupies 8 octets (Oct).

In one subembodiment, the first signaling is a MAC RAR.

In one subembodiment, the first signaling is a fallbackRAR.

In one subembodiment, the first indication field is the leftmost bit of a first octet in the first signaling.

In one subembodiment, the first indication field is an R field in the first signaling.

In one subembodiment, the first indication field is at least one bit of the last two octets in the first signaling.

In one subembodiment, the first indication field is one bit of the last two octets in the first signaling.

In one subembodiment, the first indication field is multiple bits of the last two octets in the first signaling.

In one embodiment, the first signaling comprises the first target field and the first indication field; the first indication field indicates whether the first target field indicates a TA set; the first signaling is a MAC CE.

In one subembodiment, the first signaling is an Absolute Timing Advance Command MAC CE.

In one subembodiment, the first signaling is not an Absolute Timing Advance Command MAC CE.

In one subembodiment, the first signaling is an enhanced Absolute Timing Advance Command MAC CE.

In one subembodiment, the first signaling is identified by an eLCID with a codepoint being equal to 252.

In one subembodiment, the first signaling is identified by an eLCID with a codepoint being equal to an integer no less than 0 and no greater than 226.

In one subembodiment, the first signaling is identified by a LCID with a codepoint being equal to an integer no less than 0 and no greater than 226.

In one embodiment, the first signaling comprises the first target field and the first indication field; the first indication field indicates whether the first target field indicates a TA set; the first signaling is a MAC subPDU; the first indication field belongs to the MAC subheader in the first signaling, and the first target field belongs to the MAC CE in the first signaling.

In one subembodiment, the first signaling consists of a MAC subheader which the first indication field is a part of and a MAC CE which the first target field is a part of.

In one subembodiment, the MAC CE which the first target field is a part of comprises a Timing Advance Command field.

In one subembodiment, if the first indication field is set to the first value, the first target field indicates a TA set; if the first indication field is set to the second value, the first target field does not indicate a TA set.

In one subembodiment, the first target field is at least one bit before the Timing Advance Command field in the first signaling.

In one subembodiment, if the first indication field is set to the first value, the first target field indicates a TA set; if the first indication field is set to the second value, the first target field is an R field.

In one subembodiment, the first indication field is an eLCID field.

In one subembodiment, the second value is 252.

In one subembodiment, the first value is an integer no less than 0 and no greater than 226.

In one subembodiment, the first value is an integer no less than 210 and no greater than 226.

In one subembodiment, the first indication field indicates a type of a MAC CE which the first target field is a part of.

In one subembodiment, if the first indication field is set to the first value, the MAC CE which the first target field is a part of is not an Absolute Timing Advance Command MAC CE; if the first indication field is set to the second value, the MAC CE which the first target field is a part of is an Absolute Timing Advance Command MAC CE.

In one embodiment, the first signaling comprises the first indication field, the first target field and the target cell field; the target cell field is used to indicate the candidate cell; the first indication field indicates whether the first target field is used to indicate a TA.

In one embodiment, the first signaling comprises a first indication field, a second indication field, a first target field and a second target field; the first indication field indicates whether the first target field is for timing advance, and the second indication field indicates whether the second target field is for timing advance; the first target field is a corresponding target field of the first indication field; the second target field is a corresponding target field of the second indication field.

In one embodiment, the first signaling comprises a first indication field, a second indication field, a first target field and a second target field, where the first indication field indicates whether the first target field indicates a TA, and the second indication field indicates whether the second target field indicates a TA; the first signaling is a MAC CE.

In one subembodiment, the first signaling is identified by an eLCID no less than 0 and no greater than 226.

In one subembodiment, the first signaling is identified by an eLCID no less than 210 and no greater than 226.

In one subembodiment, the first indication field and the first target field belong to at least one consecutive octet, and the second indication field and the second target field belong to at least one consecutive octet.

In one subembodiment, the first indication field and the first target field belong to 2 consecutive octets, and the second indication field and the second target field belong to 2 consecutive octets.

In one subembodiment, a TA set is indicated in the first signaling.

In one subembodiment, a TA set is not indicated in the first signaling.

In one subembodiment, positions of an octet to which the first indication field and the first target field belong and an octet to which the second indication field and the second target field belong indicate TA sets.

### Embodiment 2

Embodiment 2 illustrates a schematic diagram of a network architecture according to one embodiment of the present application, as shown in FIG. 2. FIG. 2 is a diagram illustrating a network architecture 200 of 5G New Radio (NR), Long-Term Evolution (LTE) and Long-Term Evolution Advanced (LTE-A) systems. The 5G NR/LTE/LTE-A network architecture 200 may be called a 5G System/Evolved Packet System (5GS/EPS) 200 or other suitable terminology. The 5GS/EPS 200 may comprise at least one of UEs 201, an RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. RAN includes a node 203 and other nodes 204. The node 203 provides UE 201 oriented user plane and control plane terminations. The node 203 can be connected to other nodes 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmit/Receive Point (TRP) or some other applicable terms. The node 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is an ng-eNB.

In one embodiment, the node 203 is an en-gNB.

In one embodiment, the node 203 is a Centralized Unit (CU).

In one embodiment, the node 203 is a Distributed Unit (DU).

In one embodiment, the node 203 is a UE.

In one embodiment, the node 203 is a relay.

In one embodiment, the node 203 is a Gateway.

In one embodiment, the node 204 corresponds to the third node in the present application.

In one embodiment, the node 204 corresponds to the fourth node in the present application.

In one embodiment, the node 204 is a BS.

In one embodiment, the node 204 is a BTS.

In one embodiment, the node 204 is a NB.

In one embodiment, the node 204 is a gNB.

In one embodiment, the node 204 is an eNB.

In one embodiment, the node 204 is an ng-eNB.

In one embodiment, the node 204 is an en-gNB.

In one embodiment, the node 204 is a UE.

In one embodiment, the node 204 is a relay.

In one embodiment, the node 204 is a Gateway.

In one embodiment, the node 204 is a CU.

In one embodiment, the node 204 is a DU.

In one embodiment, the node 203 and the node 204 are connected to each other via ideal backhaul.

In one embodiment, the node 203 and the node 204 are connected to each other via non-ideal backhaul.

In one embodiment, the node 203 and the node 204 simultaneously provide wireless resources to the UE 201.

In one embodiment, the node 203 and the node 204 do not simultaneously provide wireless resources to the UE 201.

In one embodiment, the node 203 and the node 204 are the same node.

In one embodiment, the node 203 and the node 204 are two different nodes.

In one embodiment, the node 203 and the node 204 belong to a same CU.

In one embodiment, the node 203 and the node 204 belong to two different CUs.

In one embodiment, the UE supports transmissions in Non-Terrestrial Network (NTN).

In one embodiment, the UE supports transmissions in Terrestrial Network (TN).

In one embodiment, the UE supports transmissions in large-delay-difference networks.

In one embodiment, the UE supports Dual Connection (DC) transmissions.

In one embodiment, the UE comprises an aircraft.

In one embodiment, the UE comprises a vehicle-mounted terminal.

In one embodiment, the UE comprises a vessel.

In one embodiment, the UE comprises an Internet-of-Things (IoT) terminal.

In one embodiment, the UE comprises an Industrial IoT (IIoT) terminal.

In one embodiment, the UE comprises a piece of equipment supporting transmissions with low delay and high reliability.

In one embodiment, the UE comprises test equipment.

In one embodiment, the UE comprises a signaling test instrument.

In one embodiment, the base station supports transmissions in NTN.

In one embodiment, the base station supports transmissions in large-delay-difference networks.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises abase station device supporting large time-delay difference.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, the base station comprises test equipment.

In one embodiment, the base station comprises a signaling test instrument.

In one embodiment, the base station comprises an Integrated Access and Backhaul-node (IAB-node).

In one embodiment, the base station comprises an IAB-donor.

In one embodiment, the base station comprises an IAB-donor-CU.

In one embodiment, the base station comprises an IAB-donor-DU.

In one embodiment, the base station comprises an IAB-DU.

In one embodiment, the base station comprises an IAB-MT.

In one embodiment, the relay comprises a relay.

In one embodiment, the relay comprises a L3 relay.

In one embodiment, the relay comprises a L2 relay.

In one embodiment, the relay comprises a Router.

In one embodiment, the relay comprises an Exchanger.

In one embodiment, the relay comprises a UE.

In one embodiment, the relay comprises a base station.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 is represented by three layers, which are L1, L2 and L3. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. The PDCP sublayer 304 provides multiplexing among variable radio bearers and logical channels. The PDCP sublayer 304 provides security by encrypting a packet and provides support for inter-cell handover. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics.

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the PHY 301 or the PHY 351.

In one embodiment, the first signaling in the present application is generated by the MAC 302 or the MAC 352.

In one embodiment, the first RRC message in the present application is generated by the RRC 306.

In one embodiment, the first measurement report in the present application is generated by the PHY 301 or the PHY 351.

In one embodiment, the first measurement report in the present application is generated by the MAC 302 or the MAC 352.

In one embodiment, each signal of the at least first signal in the present application is generated by the PHY 301 or the PHY 351.

In one embodiment, the first DCI in the present application is generated by the PHY 301 or the PHY 351.

### Embodiment 4

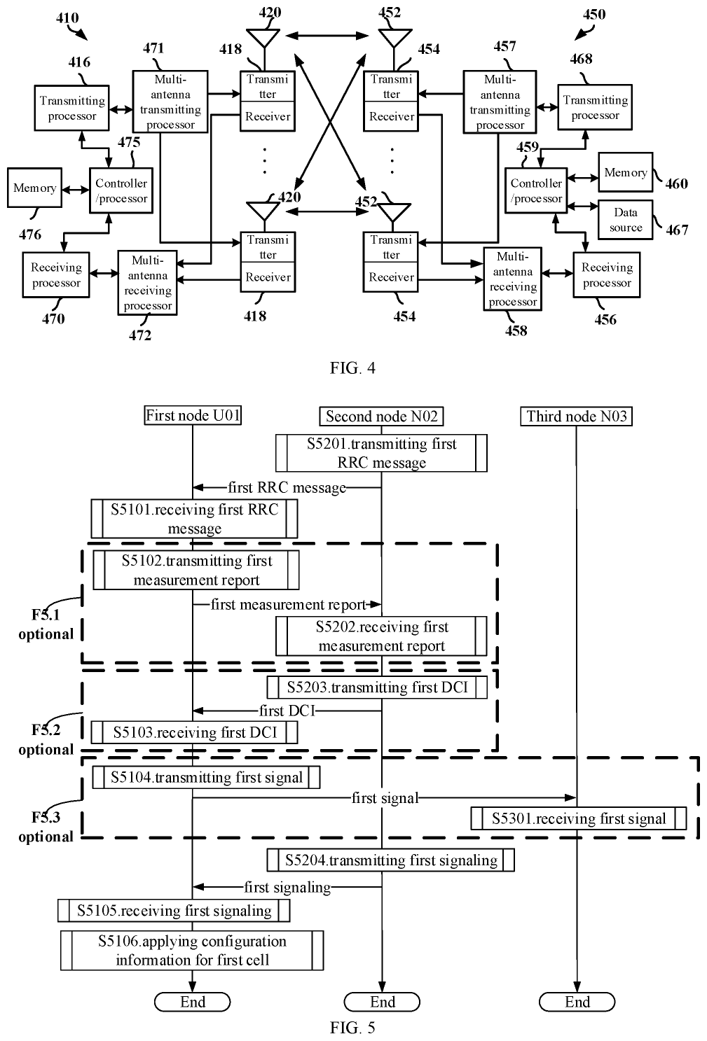

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first signaling, the first signaling comprising at least one indication field and at least one target field; herein, the first signaling is a signaling at a protocol layer below RRC sublayer; each indication field of the at least one indication field indicates whether a corresponding target field is used for a TA.

In one embodiment, the first communication device 450 comprises a memory that stores computer readable instruction program, the computer readable instruction program generates an action when executed by at least one processor, which includes: receiving a first signaling, the first signaling comprising at least one indication field and at least one target field; herein, the first signaling is a signaling at a protocol layer below RRC sublayer; each indication field of the at least one indication field indicates whether a corresponding target field is used for a TA.

In one embodiment, the second communication device 410 comprises at least one processor and at least one memory. The at least one memory comprises computer program codes; the at least one memory and the computer program codes are configured to be used in collaboration with the at least one processor. The second communication device 410 at least: transmits a first signaling, the first signaling comprising at least one indication field and at least one target field; herein, the first signaling is a signaling at a protocol layer below RRC sublayer; each indication field of the at least one indication field indicates whether a corresponding target field is used for a TA.

In one embodiment, the second communication device 410 comprises a memory that stores computer readable instruction program, the computer readable instruction program generates an action when executed by at least one processor, which includes: transmitting a first signaling, the first signaling comprising at least one indication field and at least one target field; herein, the first signaling is a signaling at a protocol layer below RRC sublayer; each indication field of the at least one indication field indicates whether a corresponding target field is used for a TA.

In one embodiment, at least one of the antenna 452, the receiver 454, the receiving processor 456, or the controller/processor 459 is used for receiving a first signaling.

In one embodiment, at least one of the antenna 420, the transmitter 418, the transmitting processor 416 or the controller/processor 475 is used for transmitting a first signaling;

In one embodiment, at least one of the antenna 452, the receiver 454, the receiving processor 456, or the controller/processor 459 is used for receiving a first RRC message.

In one embodiment, at least one of the antenna 420, the transmitter 418, the transmitting processor 416 or the controller/processor 475 is used for transmitting a first RRC message.

In one embodiment, at least one of the antenna 452, the receiver 454, the receiving processor 456, or the controller/processor 459 is used for receiving a first DCI.

In one embodiment, at least one of the antenna 420, the transmitter 418, the transmitting processor 416 or the controller/processor 475 is used for transmitting a first DCI.

In one embodiment, at least one of the antenna 452, the transmitter 454, the transmitting processor 468 or the controller/processor 459 is used for transmitting a first measurement report.

In one embodiment, at least one of the antenna 420, the receiver 418, the receiving processor 470, or the controller/processor 475 is used for receiving a first measurement report.

In one embodiment, at least one of the antenna 452, the transmitter 454, the transmitting processor 468 or the controller/processor 459 is used for transmitting each signal of at least first signal.

In one embodiment, at least one of the antenna 420, the receiver 418, the receiving processor 470, or the controller/processor 475 is used for receiving each signal of at least first signal.

In one embodiment, the first communication device 450 corresponds to the first node in the present application.

In one embodiment, the second communication device 410 corresponds to a second node in the present application.

In one embodiment, the second communication device 410 corresponds to the third node in the present application.

In one embodiment, the second communication device 410 corresponds to the fourth node in the present application.

In one embodiment, the first communication device 450 is a UE.

In one embodiment, the first communication device 450 is a base station.

In one embodiment, the first communication device 450 is a relay.

In one embodiment, the second communication device 410 is a UE.

In one embodiment, the second communication device 410 is a base station.

In one embodiment, the second communication device 410 is a relay.

### Embodiment 5

Embodiment 5 illustrates a flowchart of radio signal transmission according to one embodiment of the present application, as shown in FIG. 5. It should be particularly noted that the sequential order illustrated herein does not set any limit to the signal transmission order or implementation order in the present application.

The first node U01 receives a first RRC message in step S5101, the first RRC message comprising configuration information for at least one candidate cell; and transmits a first measurement report in step S5102; and receives a first DCI in step S5103, the first DCI indicating at least first signal; and transmits a first signal in step S5104; and receives a first signaling in step S5105, the first signaling comprising at least one indication field and at least one target field; and in step S5106, as a response to the first signaling being received, applies configuration information for a first cell.

The second node N02 transmits the first RRC message in step S5201; and receives the first measurement report in step S5202; and transmits the first DCI in step S5203; and transmits the first signaling in step S5204.

The third node N03 receives the first signal in step S5301.

In Embodiment 5, the first signaling is a signaling at a protocol layer below RRC sublayer; each indication field of the at least one indication field indicates whether a corresponding target field is used for a TA; the at least one candidate cell is configured for at least one serving cell of the first node; the first cell is a candidate cell of the at least one candidate cell; the first signaling is used to indicate the first cell; the first measurement report is a signaling at a protocol layer below RRC sublayer; each signal of the at least first signal is a physical layer signal; each signal of the at least first signal is a PRACH signal; the first DCI is used to trigger a random access procedure which the at least first signal is a part of.

In one embodiment, the first node U01 is a UE.

In one embodiment, the first node U01 is a base station.

In one embodiment, the first node U01 is a relay device.

In one embodiment, the second node N02 is a base station.

In one embodiment, the second node N02 is a UE.

In one embodiment, the second node N02 is a relay device.

In one embodiment, the third node N03 is a base station.

In one embodiment, the third node N03 is a UE.

In one embodiment, the third node N03 is a relay device.

In one embodiment, the first node U01 is a UE, the second node N02 is a base station, and the third node N03 is a base station.

In one embodiment, the first node U01 is a UE, the second node N02 is a UE, and the third node N03 is a UE.

In one embodiment, the first node U01 is a UE, the second node N02 is a UE, and the third node N03 is a base station.

In one embodiment, the first node U01 is a base station, the second node N02 is a base station, and the third node N03 is a base station.

In one embodiment, the first node U01 is a UE, the second node N02 is a base station, and the third node N03 is a UE.

In one embodiment, the third node N03 and the second node N02 are co-located.

In one embodiment, the third node N03 and the second node N02 are non-co-located.

In one embodiment, the third node N03 is the second node N02.

In one embodiment, the third node N03 is not the second node N02.

In one embodiment, the third node N03 and the second node N02 are respectively two DUs that belong to a same CU.

In one embodiment, the third node N03 and the second node N02 are DUs that belong to two different CUs.

In one embodiment, the second node N02 is a maintenance base station for a serving cell of the first node U01.

In one embodiment, the second node N02 is a maintenance base station for a first serving cell of the first node U01.

In one subembodiment, the first serving cell is a Special Cell (SpCell).

In one subembodiment, the first serving cell is a Primary SCG Cell (PSCell).

In one subembodiment, the first serving cell is a Primary Cell (PCell).

In one embodiment, the third node N03 is a maintenance base station for the given candidate cell.

In one embodiment, the third node N03 is a receiver of the at least first signal; the at least first signal is the first signal.

In one embodiment, the third node N03 is a receiver of the first signal; the at least first signal include multiple signals, the first signal being one of the multiple signals.

In one embodiment, the third node N03 determines a timing advance according to at least the first signal.

In one embodiment, the third node N03 determines a timing advance according to one of the at least first signal.

In one embodiment, this embodiment does not set a limit on whether the transmitter of the first DCI is the same as the transmitter of the first RRC message.

In one embodiment, before the action of receiving a first signaling, the first RRC message is received.

In one embodiment, the first RRC message includes at least one RRC message.

In one embodiment, the first RRC message is an RRC message.

In one embodiment, the first RRC message comprises at least one RRC Information Element (IE).

In one embodiment, the first RRC message includes at least one RRC Field

In one embodiment, the first RRC message is transmitted via a Common Control Channel (CCCH).

In one embodiment, the first RRC message is transmitted via a Signaling Radio Bearer 1 (SRB1).

In one embodiment, the first RRC message is transmitted via a Signaling Radio Bearer 3 (SRB3).

In one embodiment, the first RRC message includes at least one RRCReconfiguration message.

In one embodiment, the first RRC message includes at least one RRCResume message.

In one embodiment, the first RRC message includes at least one RRCReestablishment message.

In one embodiment, the first RRC message includes at least one CellGroupConfig Field.

In one embodiment, the first RRC message includes at least one SpCellConfig Field.

In one embodiment, the first RRC message includes at least one reconfigurationWithSync field.

In one embodiment, the first RRC message includes at least one spCellConfigCommon field.

In one embodiment, the first RRC message comprises a ServingCellConfigCommon IE for each of the at least one candidate cell.

In one embodiment, the first RRC message comprises a DownlinkConfigCommon IE for each of the at least one candidate cell.

In one embodiment, the first RRC message comprises an UplinkConfigCommon IE for each of the at least one candidate cell.

In one embodiment, the first RRC message comprises a BWP-DownlinkCommon IE for each of the at least one candidate cell.

In one embodiment, the first RRC message comprises a BWP-UplinkCommon IE for each of the at least one candidate cell.

In one embodiment, the first RRC message comprises an ssb-PositionsInBurst field for each of the at least one candidate cell.

In one embodiment, the first RRC message comprises a candidate configuration identifier for each of the at least one candidate cell.

In one embodiment, each of the at least one candidate cell is configured with one candidate configuration identifier.

In one embodiment, any two of the at least one candidate cell have different candidate configuration identifiers.

In one embodiment, a candidate configuration identifier of any one of the at least one candidate cell is an integer no less than 0 and no greater than K1, K1 being a positive integer.

In one embodiment, K1 is equal to 8.

In one embodiment, K1 is equal to 16.

In one embodiment, the action of applying configuration information for the first cell is dependent on the first signaling.

In one embodiment, the first signaling indicates that the first cell is used to determine the application of configuration information for the first cell.

In one embodiment, the first signaling being received is used to trigger the action of applying configuration information for the first cell.

In one embodiment, when the first signaling is received, applying configuration information for the first cell.

In one embodiment, at least after the first signaling is received, applying configuration information for the first cell.

In one embodiment, the at least one candidate cell is/are candidate cell(s) for each of at least one serving cell of the first node U01.

In one embodiment, the at least one candidate cell is/are candidate cell(s) for only one serving cell of the first node U01.

In one embodiment, the at least one candidate cell is/are candidate cell(s) for multiple serving cells of the first node U01.

In one embodiment, the at least one candidate cell is/are configured for only one serving cell of the first node U01.

In one embodiment, the at least one candidate cell is/are configured for multiple serving cells of the first node U01.

In one embodiment, each of the at least one candidate cell is a LTM candidate cell.

In one embodiment, at least one of the at least one candidate cell is a Conditional Handover (CHO) candidate cell.

In one embodiment, at least one of the at least one candidate cell is a Conditional PSCell Change (CPC) candidate cell.

In one embodiment, the at least one serving cell is the first serving cell.

In one embodiment, the at least one serving cell includes/include at least the first serving cell.

In one embodiment, the at least one serving cell belongs/belong to a same cell group.

In one embodiment, the at least one serving cell belongs/belong to a Master cell group (MCG).

In one embodiment, the at least one serving cell belongs/belong to a Secondary Cell Group (SCG).

In one embodiment, the first signaling is a LTM Command.

In one embodiment, the first signaling is a Handover Command.

In one embodiment, the first signaling is used to indicate a switch to the first cell.

In one embodiment, the first signaling is used to indicate the application of configuration information for the first cell.

In one embodiment, the first signaling indicates a candidate configuration identifier of the first cell.

In one embodiment, the first signaling explicitly indicates the first cell.

In one embodiment, the first signaling implicitly indicates the first cell.

In one embodiment, a field in the first signaling indicates the first cell.

In one embodiment, a field in the first signaling is associated with the first cell.

In one embodiment, the dotted-line box F5.1 is optional.

In one embodiment, the dotted-line box F5.1 does not exist.

In one embodiment, the dotted-line box F5.1 exists.

In one embodiment, after the action of receiving the first RRC message and before the action of receiving a first signaling, the first measurement report is transmitted.

In one subembodiment, the first measurement report is used for triggering the first signaling.

In one subembodiment, a time of transmitting the first measurement report is earlier than a time of receiving the first signaling.

In one subembodiment, the first measurement report comprises measurement results of at least the first cell.

In one subembodiment, the first measurement report comprises measurement results of only the first cell.

In one subembodiment, the first measurement report comprises measurement results of multiple cells, with the first cell being one of the multiple cells.

In one subembodiment, the first measurement report indicates at least the first cell.

In one subembodiment, the first measurement report comprises one identifier of at least the first cell.

In one subembodiment, the first measurement report comprises one index of at least the first cell.

In one subembodiment, the first measurement report is a piece of Uplink Control Information (UCI).

In one subembodiment, the first measurement report is a MAC CE.

In one subembodiment, the first measurement report is transmitted via a Physical Uplink Control Channel (PUCCH).

In one subembodiment, the first measurement report is transmitted via a Physical Uplink Shared Channel (PUSCH).

In one subembodiment, the first measurement report is transmitted via an Uplink Shared Channel (UL-SCH).

In one subembodiment, the first measurement report comprises Layer 1 (L1) measurement results.

In one subembodiment, the first measurement report is L1 measurement results.

In one subembodiment, the L1 measurement results include an S-RSRP measured for SSB.

In one subembodiment, the L1 measurement results include a CSI-RSRP measured for CSI-RS.

In one subembodiment, the L1 measurement results include filtered measurement results.

In one subembodiment, the L1 measurement results include unfiltered measurement results.

In one subembodiment, the L1 measurement results include a Reference Signal Received Power (RSRP).

In one subembodiment, the L1 measurement results include a Reference Signal Received Quality (RSRQ).

In one subembodiment, the L1 measurement results include a Signal-to-noise and interference ratio (SINR).

In one subembodiment, the L1 measurement results include an L1-RSRP.

In one subembodiment, the L1 measurement results include an L1-RSRQ.

In one subembodiment, the L1 measurement results include an L1-SINR.

In one subembodiment, the L1 measurement results include a measurement result of SSB.

In one embodiment, the dotted-line box F5.2 is optional.

In one embodiment, the dotted-line box F5.2 does not exist.

In one embodiment, the dotted-line box F5.2 exists.

In one subembodiment, the first DCI is received on the first serving cell of the first node U01. In one subembodiment, the first DCI is used for a Physical Downlink Control Channel (PDCCH) order.

In one subembodiment, the first DCI is a PDCCH order.

In one subembodiment, the first DCI is a PDCCH order used to trigger a random access procedure.

In one embodiment, the first DCI is identified by a Cell Radio Network Temporary Identifier (C-RNTI) of the first node U01 in the first serving cell.

In one subembodiment, the first DCI is identified by a C-RNTI of the first node U01 in a cell group to which the first serving cell belongs.

In one subembodiment, the first DCI is used to indicate initiation of a random access procedure on a given candidate cell.

In one subembodiment, the first DCI is used to indicate transmitting of the first signal on a given candidate cell.

In one subembodiment, the first DCI implicitly indicates the given candidate cell.

In one subembodiment, the first DCI explicitly indicates the given candidate cell.

In one subembodiment, the first DCI comprises a first DCI field, the value of the first DCI field being indexed to the given candidate cell.

In one subembodiment, the first DCI comprises a first DCI field, the value of the first DCI field being associated with the given candidate cell.

In one subembodiment, the first DCI comprises a first DCI field, the first DCI field being used to indicate a cell that transmits a Preamble.

In one subembodiment, the first DCI comprises a first DCI field, the first DCI field being used to indicate a cell that initiates a random access procedure.

In one subembodiment, the first DCI comprises a first DCI field, the first DCI field being used to indicate a cell to which random access resources belong.

In one subembodiment, the first DCI comprises a first DCI field, the first DCI field being used to indicate the given candidate cell.

In one subembodiment, the first DCI comprises a first DCI field, the first DCI field being used to indicate a candidate configuration identifier of the given candidate cell.

In one subembodiment, the first DCI comprises a first DCI field, the first DCI field being used to indicate a PCI of the given candidate cell.

In one subembodiment, the first DCI comprises a first DCI field, the first DCI field being used to indicate an index of the given candidate cell among at least one cell.

In one subembodiment, the first DCI comprises a first DCI field, the first DCI field being used to indicate a position of the given candidate cell among at least one cell.

In one subembodiment, the first DCI comprises a first DCI field, the first DCI field being used to indicate a TAG to which the given candidate cell belongs.

In one subembodiment, the first DCI field occupies at least 1 bit.

In one subembodiment, the first DCI field occupies 2 bits.

In one subembodiment, the first DCI field occupies 3 bits.

In one subembodiment, the first DCI field occupies 4 bits.

In one subembodiment, a format of the first DCI is DCI format 1_1.

In one subembodiment, a format of the first DCI is DCI format 1_0.

In one subsidiary embodiment of the subembodiment, the first DCI comprises at least one Identifier for DCI formats field, and, the Identifier for DCI formats field is set to 1.

In one subsidiary embodiment of the subembodiment, the first DCI comprises a Frequency domain resource assignment field, and, the Frequency domain resource assignment field is set to all-ones.

In one subembodiment, the first DCI indicates random access resources of the given candidate cell.

In one subsidiary embodiment of the subembodiment, the first DCI comprises at least one of a Random Access Preamble index field or an Uplink (UL)/Supplementary Uplink (SUL) indicator field or a Synchronization Signals (SS)/Physical broadcast channel (PBCH) index field or a Physical Random Access Channel (PRACH) Mask index field.

In one subembodiment, the first DCI does not indicate random access resources of the given candidate cell.

In one subsidiary embodiment of the subembodiment, the random access resources of the given candidate cell are pre-configured.

In one subsidiary embodiment of the subembodiment, the first RRC message indicates random access resources of the given candidate cell.

In one subsidiary embodiment of the subembodiment, the first RRC message comprises random access resources of one or more candidate cells among the at least one candidate cell.

In one subsidiary embodiment of the subembodiment, the first DCI does not comprise any of a Random Access Preamble index field or a UL/SUL indicator field or a SS/PBCH index field or a PRACH Mask index field.

In one subembodiment, the random access resources of the given candidate cell include an index of the first signal.

In one subembodiment, the random access resources of the given candidate cell include an uplink carrier associated with the first signal.

In one subembodiment, the random access resources of the given candidate cell include a PRACH mask associated with the first signal.

In one subembodiment, the random access resources of the given candidate cell include an SSB associated with the first signal.

In one subembodiment, as a response to the first DCI being received, triggering a random access procedure.

In one subembodiment, as a response to the first DCI being received, triggering a timing request. In one subembodiment, as a response to the first DCI being received, a random access procedure to which the at least first signal belongs is initiated.

In one subembodiment, as a response to the first DCI being received, a random access procedure to which the at least first signal belongs is triggered.

In one subembodiment, as a response to the first DCI being received, a random access procedure to which the at least first signal belongs is started.

In one subembodiment, a random access procedure to which the at least first signal belongs is a response to the first DCI.

In one embodiment, the dotted-line box F5.3 is optional.

In one embodiment, the dotted-line box F5.3 does not exist.

In one embodiment, the dotted-line box F5.3 exists.

In one embodiment, before the action of receiving a first signaling, the at least first signal is transmitted.

In one subembodiment, after the action of transmitting a first measurement report, transmitting the at least first signal.

In one subembodiment, after the action of receiving a first RRC message, transmitting the at least first signal.

In one subembodiment, upon or after expiration of a timer, transmitting the at least first signal.

In one subembodiment, upon or after expiration of a timeAlignmentTimer, transmitting the at least first signal.

In one subembodiment, upon or after expiration of a timer whose name includes timeAlignmentTimer, transmitting the at least first signal.

In one subembodiment, as a response to the first DCI being received, transmitting the at least first signal.

In one subembodiment, the action of transmitting at least first signal means: to transmit the first signal.

In one subembodiment, the action of transmitting at least first signal means: to transmit multiple signals, with the first signal being one of the multiple signals.

In one subembodiment, the multiple signals are transmitted on at least two different cells.

In one subembodiment, the multiple signals are transmitted on a same cell.

In one subembodiment, the multiple signals are overlapping in time domain.

In one subembodiment, the multiple signals are non-overlapping in time domain.

In one subembodiment, when the first signal is transmitted, at least one timing request is pending for the first cell.

In one subembodiment, when the first signal is transmitted, canceling at least one timing request.

In one subembodiment, when the first signal is transmitted, canceling the at least one timing request for the first cell.

In one subembodiment, when the first signal is transmitted, canceling each timing request pending for the first cell.

In one subembodiment, when the first signal is transmitted, the at least one timing request for the first cell is not canceled

In one subembodiment, the first signal is used to determine a timing advance on the first cell.

In one subembodiment, the first signal is used to trigger a timing advance on the first cell.

In one subembodiment, the first signal is used to request a timing advance on the first cell.

In one subembodiment, the first signal is used to obtain a timing advance on the first cell.

In one subembodiment, at least one timing request for the first cell is used to trigger the first signal.

In one subembodiment, at least one timing request is used to trigger the at least first signal.

In one subembodiment, at least one timing request for the first cell is used to trigger the at least first signal.

In one subembodiment, at least one timing request for at least one cell is used to trigger the at least first signal.

In one subembodiment, each signal of the at least first signal is a Preamble in Section 5.1 of TS 38.321.

In one subembodiment, each signal of the at least first signal is not a Preamble in Section 5.1 of TS 38.321.

In one subembodiment, a physical layer channel for bearing each signal of the at least first signal in the present application is a Physical Random Access Channel (PRACH).

In one subembodiment, a physical layer channel for bearing each signal of the at least first signal in the present application is a Physical Uplink Control Channel (PUCCH).

In one subembodiment, a physical layer channel for bearing each signal of the at least first signal in the present application is a Physical Uplink Shared Channel (PUSCH).

In one subembodiment, each of the at least first signal is used by the second node to calculate a timing advance on the first cell.

In one subembodiment, each of the at least first signal is an uplink signal.

In one subembodiment, each of the at least first signal is a physical layer signal.

In one subembodiment, each of the at least first signal occupies resources of a physical layer channel.

In one subembodiment, each of the at least first signal is a Preamble.

In one subembodiment, each of the at least first signal is a PRACH signal.

In one subembodiment, each of the at least first signal is an SRS.

In one subembodiment, each of the at least first signal is a PUCCH signal.

In one subembodiment, each of the at least first signal is any of a PRACH signal or an SRS.

In one subembodiment, the at least first signal includes/include at least one PRACH signal.

In one subembodiment, the at least first signal includes/include at least one PUCCH signal.

In one subembodiment, the at least first signal includes/include at least one SRS.

In one subembodiment, the at least first signal include at least one PRACH signal and at least one SRS.

In one subembodiment, the PRACH signal is used for random access.

In one subembodiment, the PRACH signal refers to a Preamble.

In one subembodiment, the PRACH signal refers to a Preamble used for 4-step random access.

In one subembodiment, the PRACH signal refers to a Preamble used for 2-step random access.

In one subembodiment, the PRACH signal refers to a Preamble used for Contention Free Random Access (CFRA).

In one subembodiment, the PRACH signal refers to a Preamble used for Contention Based Random Access (CBRA).

In one subembodiment, the PRACH signal refers to a Random access preamble.

In one embodiment, the first cell is identical to the given candidate cell.

In one embodiment, the first cell is different from the given candidate cell.

In one embodiment, when the first signaling is received, canceling the at least one timing request for the first cell.

In one embodiment, when the first signaling is received, canceling each timing request pending for the first cell.

In one embodiment, when the first signaling is received, canceling any timing request for the first cell.

In one embodiment, when the first signaling is received, canceling any timing request pending for the first cell.

In one embodiment, when the first signaling is received, canceling at least one timing request that is pending.

In one embodiment, when the first signaling is received, canceling any timing request that is pending.

In one embodiment, when the first signaling is received, canceling any timing request pending for a Medium Access Control (MAC) entity associated with the first cell.

### Embodiment 6

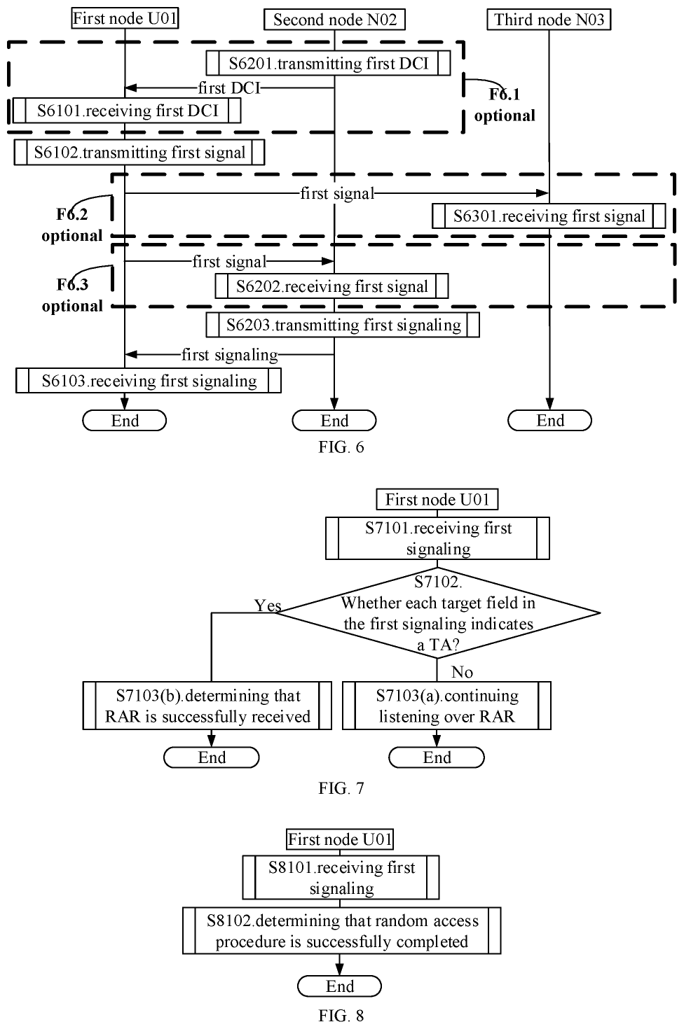

Embodiment 6 illustrates a flowchart of signal transmission according to another embodiment of the present application, as shown in FIG. 6. It should be particularly noted that the sequence illustrated herein does not set any limit to the signal transmission order or implementation order in the present application.

The first node U01 receives a first DCI in step S6101, the first DCI indicating at least first signal; and transmits the at least first signal in step S6102; and receives a first signaling in step S6103, the first signaling comprising at least one indication field and at least one target field.

The second node N02 transmits the first DCI in step S6201; and receives the first signal in step S6202; and transmits the first signaling in step S6203.

The third node N03 receives the first signal in step S6301.

In Embodiment 6, the first signaling is a signaling at a protocol layer below RRC sublayer; each indication field of the at least one indication field indicates whether a corresponding target field is used for a TA; each signal of the at least first signal is a physical layer signal.

In one embodiment, the first node U01 is a UE.

In one embodiment, the first node U01 is a base station.

In one embodiment, the first node U01 is a relay device.

In one embodiment, the second node N02 is a base station.

In one embodiment, the second node N02 is a UE.

In one embodiment, the second node N02 is a relay device.

In one embodiment, the third node N03 is a base station.

In one embodiment, the third node N03 is a UE.

In one embodiment, the third node N03 is a relay device.

In one embodiment, the first node U01 is a UE, the second node N02 is a base station, and the third node N03 is a base station.

In one embodiment, the first node U01 is a base station, the second node N02 is a base station, and the third node N03 is a base station.

In one embodiment, the third node N03 and the second node N02 are co-located.

In one embodiment, the third node N03 and the second node N02 are non-co-located.

In one embodiment, the third node N03 and the second node N02 are respectively two DUs that belong to a same CU.

In one embodiment, the third node N03 and the second node N02 are DUs that belong to two different CUs.

In one embodiment, the third node N03 and the second node N02 belong to a same gNB.

In one embodiment, the third node N03 and the second node N02 belong to different gNBs.

In one embodiment, the third node N03 is a TRP, and the second node N02 is another TRP.

In one embodiment, the TRP is associated with a reference signal set, while the other TRP is associated with another reference signal set, the reference signal set and the other reference signal set being different from each other.

In one embodiment, the TRP is associated with a TA set, while the other TRP is associated with another TA set, the TA set and the other TA set being different from each other.

In one embodiment, the TRP and the other TRP are associated with different T_{A}s.

In one embodiment, the dotted-line box F6.1 is optional.

In one embodiment, the dotted-line box F6.1 does not exist.

In one embodiment, the dotted-line box F6.1 exists.

In one subembodiment, the first DCI is received on the first serving cell of the first node U01.

In one subembodiment, the first DCI is received on a TRP of the first serving cell of the first node U01.

In one subembodiment, the first DCI is received on a Secondary Cell (SCell) of the first node U01.

In one subembodiment, the first DCI is received on a TRP of one SCell of the first node U01.

In one subembodiment, the first DCI is used for a PDCCH order.

In one subembodiment, the first DCI is a PDCCH order.

In one subembodiment, the first DCI is a PDCCH order used to trigger a random access procedure.

In one embodiment, the first DCI is identified by a Cell Radio Network Temporary Identifier (C-RNTI) of the first node U01 in the first serving cell.

In one subembodiment, the first DCI is identified by a C-RNTI of the first node U01 in a cell group to which the first serving cell belongs.

In one subembodiment, the first DCI is used to indicate initiation of a random access procedure on a given TRP.

In one subembodiment, the first DCI is used to indicate transmitting of the first signal on a given TRP.

In one subembodiment, the first DCI implicitly indicates the given TRP.

In one subembodiment, the first DCI explicitly indicates the given TRP.

In one subembodiment, a search space for receiving the first DCI is associated with the given TRP.

In one subembodiment, a Transmission Configuration Indicator (TCI) state for receiving the first DCI is associated with the given TRP.

In one subembodiment, a Control Resource Set (CORESET) for receiving the first DCI is associated with the given TRP.

In one subembodiment, the first DCI comprises a first DCI field, the value of the first DCI field being indexed to the given TRP.

In one subembodiment, the first DCI comprises a first DCI field, the value of the first DCI field being associated with the given TRP.

In one subembodiment, the first DCI comprises a first DCI field, the first DCI field being used to indicate a TRP that transmits a Preamble.

In one subembodiment, the first DCI comprises a first DCI field, the first DCI field being used to indicate a TRP that initiates a random access procedure.

In one subembodiment, the first DCI comprises a first DCI field, the first DCI field being used to indicate a TRP to which random access resources belong.

In one subembodiment, the first DCI comprises a first DCI field, the first DCI field being used to indicate the given TRP.

In one subembodiment, the first DCI comprises a first DCI field, the first DCI field being used to indicate a reference signal resource set associated with the given TRP

In one subembodiment, the first DCI comprises a first DCI field, the first DCI field being used to indicate a configuration identity associated with the given TRP.

In one subembodiment, the first DCI comprises a first DCI field, the first DCI field being used to indicate a CORESET associated with the given TRP.

In one subembodiment, the first DCI comprises a first DCI field, the first DCI field being used to indicate a TCI state associated with the given TRP.

In one subembodiment, the first DCI comprises a first DCI field, the first DCI field being used to indicate a TA set associated with the given TRP

In one subembodiment, the first DCI field occupies at least 1 bit.

In one subembodiment, the first DCI field occupies 2 bits.

In one subembodiment, the first DCI field occupies 3 bits.

In one subembodiment, the first DCI field occupies 4 bits.

In one subembodiment, a format of the first DCI is DCI format 1_1.

In one subembodiment, a format of the first DCI is DCI format 1_0.

In one subsidiary embodiment of the subembodiment, the first DCI comprises at least one Identifier for DCI formats field, and, the Identifier for DCI formats field is set to 1.

In one subsidiary embodiment of the subembodiment, the first DCI comprises a Frequency domain resource assignment field, and, the Frequency domain resource assignment field is set to all-ones.

In one subembodiment, the first DCI indicates random access resources of the given TRP.

In one subsidiary embodiment of the subembodiment, the first DCI comprises at least one of a Random Access Preamble index field or an Uplink (UL)/Supplementary Uplink (SUL) indicator field or a Synchronization Signals (SS)/Physical broadcast channel (PBCH) index field or a Physical Random Access Channel (PRACH) Mask index field.

In one subembodiment, the first DCI does not indicate random access resources of the given TRP.

In one subsidiary embodiment of the subembodiment, the random access resources of the given TRP are pre-configured.

In one subsidiary embodiment of the subembodiment, the first DCI does not comprise any of a Random Access Preamble index field or a UL/SUL indicator field or a SS/PBCH index field or a PRACH Mask index field.

In one subembodiment, the random access resources of the given TRP include an index of the first signal.

In one subembodiment, the random access resources of the given TRP include an uplink carrier associated with the first signal.

In one subembodiment, the random access resources of the given TRP include a PRACH mask associated with the first signal.

In one subembodiment, the random access resources of the given TRP include an SSB associated with the first signal.

In one subembodiment, as a response to the first DCI being received, a random access procedure to which the at least first signal belongs is initiated.

In one subembodiment, as a response to the first DCI being received, a random access procedure to which the at least first signal belongs is triggered.

In one subembodiment, as a response to the first DCI being received, a random access procedure to which the at least first signal belongs is started.

In one subembodiment, a random access procedure to which the at least first signal belongs is a response to the first DCI.

In one embodiment, the dotted-line box F6.2 is optional.

In one embodiment, the dotted-line box F6.3 is optional.

In one embodiment, at least one of the dotted-line box F6.2 or the dotted-line box F6.3 exists.

In one embodiment, before the action of receiving a first signaling, the at least first signal is transmitted.

In one embodiment, as a response to the first DCI being received, transmitting the at least first signal.

In one embodiment, transmitting the at least first signal.

In one embodiment, transmitting the at least first signal on or after expiration of a timeAlignmentTimer.

In one embodiment, transmitting the at least first signal on or after expiration of a timer whose name includes timeAlignmentTimer.

In one embodiment, the action of transmitting at least first signal means: to transmit the first signal.

In one embodiment, the action of transmitting at least first signal means: to transmit multiple signals, with the first signal being one of the multiple signals.

In one embodiment, the multiple signals are transmitted on at least two different cells.

In one embodiment, the multiple signals are transmitted on a same cell.

In one embodiment, the multiple signals are overlapping in time domain.

In one embodiment, the multiple signals are non-overlapping in time domain.

In one embodiment, each signal of the at least first signal is a PRACH signal.

In one embodiment, each signal of the at least first signal is an SRS.

In one embodiment, each signal of the at least first signal is a PUCCH signal.

In one embodiment, each signal of the at least first signal is any of a PRACH signal or an SRS.

In one embodiment, the at least first signal includes/include at least one PRACH signal.

In one embodiment, the at least first signal includes/include at least one PUCCH signal.

In one embodiment, the at least first signal includes/include at least one SRS.

In one embodiment, the at least first signal include at least one PRACH signal and at least one SRS.

### Embodiment 7

Embodiment 7 illustrates a flowchart of transmission of response to a first signaling according to one embodiment of the present application, as shown in FIG. 7. It should be particularly noted that the sequence illustrated herein does not set any limit to the signal transmission order or implementation order in the present application.

The first node U01 receives a first signaling in step S7101; and in step S7102, as a response to the action of receiving a first signaling, determines whether each target field in the first signaling indicates a TA; and in step S7103(a), when at least one target field in the first signaling does not indicate a TA, continues listening over a random access response (RAR); in step S7103(b), when each target field in the first signaling indicates a TA, determines that a random access response (RAR) is successfully received.

In one embodiment, the action of determining that a random access response is successfully received means: determining that a random access response for the first signal is received successfully.

In one embodiment, the action of determining that a random access procedure is successfully completed means: determining that a random access response for the at least first signal is received successfully.

In one embodiment, the action of continuing listening over a random access response means: continuing listening over a random access response for the first signal.

In one embodiment, the action of continuing listening over a random access response means: continuing listening over a random access response for the at least first signal.

In one embodiment, when a first time window is running, the first signaling is received.

In one embodiment, during the time while a first time window is running, the first signaling is received.

In one embodiment, the first time window is a ra-ResponseWindow.

In one embodiment, accompanied with the at least first signal, starting the first time window.

In one embodiment, accompanied with one signal of the at least first signal, starting the first time window.

In one embodiment, accompanied with one signal of the at least first signal, starting or restarting the first time window.

In one embodiment, the action of determining that a random access response is successfully received means: assuming that a random access response is received successfully.

In one embodiment, the action of determining that a random access response is successfully received means: a random access response shall be deemed as having been received successfully.

In one embodiment, the action of determining that a random access response is successfully received means: considering this Random Access Response reception successful.

In one embodiment, when at least one target field in the first signaling does not indicate a TA, the first time window keeps running; the first time window keeping running is used to determine that listening over the random access response is continued.

In one embodiment, when at least one target field in the first signaling does not indicate a TA, the action of determining that a random access response is successfully received is not performed; that the action of determining that a random access response is successfully received is not performed is used to determine that listening over the random access response is continued.

### Embodiment 8

Embodiment 8 illustrates a flowchart of transmission of response to a first signaling according to another embodiment of the present application, as shown in FIG. 8. It should be particularly noted that the sequence illustrated herein does not set any limit to the signal transmission order or implementation order in the present application.

The first node U01 receives a first signaling in step S8101; and in step S8102, as a response to the action of receiving a first signaling, determines that a random access procedure is successfully completed.

In one embodiment, the action of determining that a random access procedure is successfully completed means: assuming that the random access procedure is successfully completed.

In one embodiment, the action of determining that a random access procedure is successfully completed means: assuming that the random access procedure which the first signal is a part of is successfully completed.

In one embodiment, the action of determining that a random access procedure is successfully completed means: assuming that the random access procedure which the at least first signal is a part of is successfully completed.

In one embodiment, as a response to the action of receiving a first signaling, determine that a random access response is received successfully, and that a random access procedure is successfully completed.

In one embodiment, as a response to the action of receiving a first signaling, determine that a random access response is received successfully; and after the action of determining that a random access response is received successfully, determine that a random access procedure is successfully completed.

In one embodiment, as a response to the action of receiving a first signaling, process at least one of the at least one target field, and determine that a random access response is received successfully, and that a random access procedure is successfully completed.

In one embodiment, as a response to the action of receiving a first signaling, process at least one of the at least one target field; and after the action of processing at least one of the at least one target field, determine that a random access response is received successfully; and after the action of determining that a random access response is received successfully, determine that a random access procedure is successfully completed.

### Embodiment 9

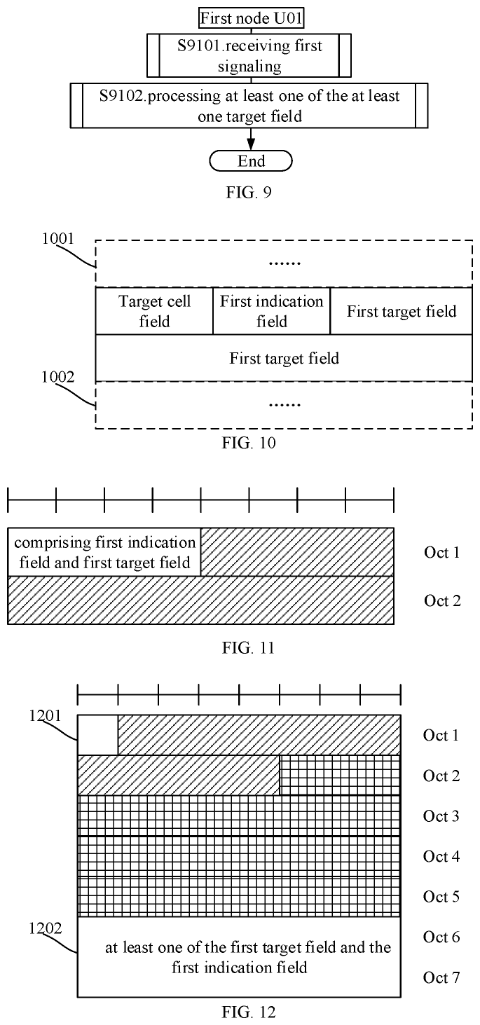

Embodiment 9 illustrates a flowchart of transmission of response to a first signaling according to yet another embodiment of the present application, as shown in FIG. 9. It should be particularly noted that the sequence illustrated herein does not set any limit to the signal transmission order or implementation order in the present application.

The first node U01 receives a first signaling in step S9101; and in step S9102, processes at least one of the at least one target field as a response to the action of receiving a first signaling.

In Embodiment 9, the at least one of the at least one target field indicates a TA.

In one embodiment, as a response to the action of receiving a first signaling, process a target field of the at least one target field that indicates a TA.

In one embodiment, as a response to the action of receiving a first signaling, if a target field of the at least one target field indicates a TA, processing the target field.

In one embodiment, as a response to the action of receiving a first signaling, if a corresponding indication field of a target field of the at least one target field is set to the first value, processing the target field.

In one embodiment, each of the at least one corresponding indication field of the at least one target field is set to the first value.

In one embodiment, the action of processing at least one of the at least one target field means: processing each target field of the at least one target field.

In one embodiment, the action of processing at least one of the at least one target field means: respectively processing the at least one of the at least one target field.

In one embodiment, processing a target field means: processing a timing advance (TA) indicated by the target field.

In one embodiment, processing a target field means: applying the target field.

In one embodiment, processing a target field means: applying the value of the target field.

In one embodiment, processing a target field means: applying a timing advance (TA) indicated by the target field.

In one embodiment, processing a target field means: adjusting an uplink transmission timing according to a timing advance (TA) indicated by the target field.

In one embodiment, processing a target field means: adjusting an uplink transmission timing of a corresponding timing advance set according to a timing advance (TA) indicated by the target field.

### Embodiment 10

Embodiment 10 illustrates a schematic diagram of the structure of a first signaling according to the first embodiment of the present application, as shown in FIG. 10. In FIG. 10, the dotted-line boxes 1001 and 1002 indicate other fields in the first signaling.

In Embodiment 10, the first signaling comprises the first indication field, the first target field and the target cell field; the target cell field is used to indicate the first cell; the first indication field indicates whether the first target field is used to indicate a TA.

In one embodiment, at least one of the dotted-line box 1001 or the dotted-line box 1002 exists.

In one embodiment, neither of the dotted-line box 1001 and the dotted-line box 1002 exists.

In one embodiment, the first signaling comprises the first indication field, the first target field and the target cell field; the target cell field is used to indicate the first cell.

In one embodiment, the target cell field is used to indicate an identity of the first cell.

In one embodiment, the target cell field is used to indicate a candidate configuration identifier of the first cell.

In one embodiment, a value of the target cell field is indexed to the first cell.

In one embodiment, the target cell field occupies at least one bit.

In one embodiment, the target cell field occupies 3 bits.

In one embodiment, the target cell field occupies 1 bit.

In one embodiment, this embodiment does not set a limit on the sizes or locations of the first indication field, the first target field and the target cell field of the present application in the first signaling.

### Embodiment 11

Embodiment 11 illustrates a schematic diagram of the structure of a first signaling according to the second embodiment of the present application, as shown in FIG. 11. The first 4 bits of octet 1 in the first signaling include the first indication field and the first target field; the slash-filled box is used for a Timing Advance Command field.

In Embodiment 11, the first signaling comprises the first target field and the first indication field; the first indication field indicates whether the first target field is used to indicate a TA set; the first signaling is a MAC CE.

In one embodiment, the slash-filled box is a Timing Advance Command field.

In one embodiment, the first signaling occupies two octets.

In one embodiment, the first signaling comprises the first target field, the first indication field and a Timing Advance Command field.

In one embodiment, the first indication field is located before the first target field.

In one embodiment, the first indication field is located before the first target field, and the first indication field is adjacent to the first target field.

In one embodiment, the first indication field occupies 1 bit.

In one embodiment, the first indication field occupies 2 bits.

In one embodiment, the first target field occupies 1 bit.

In one embodiment, the first target field occupies 2 bits.

In one embodiment, the first 4 bits of octet 1 (Oct 1) in the first signaling include at least one R field.

In one embodiment, the first 4 bits of octet 1 (Oct 1) in the first signaling do not include any R field.

In one embodiment, if the first indication field is set to the second value, the first target field is reserved.

In one embodiment, this embodiment does not set a limit on the sizes or locations of the first indication field and the first target field of the present application in the first signaling.

### Embodiment 12

Embodiment 12 illustrates a schematic diagram of the structure of a first signaling according to the third embodiment of the present application, as shown in FIG. 12. The box 1201 is the leftmost bit of a first octet in the first signaling; the box 1202 is the last two octets in the first signaling, and, the last two octets in the first signaling include at least one of the first target field and the first indication field; the slash-filled box is used for a Timing Advance Command field; and the cross-filled box is used for a UL grant field.

In Embodiment 12, the first signaling comprises the first target field and the first indication field; the first indication field indicates whether the first target field is used to indicate a TA, or, the first indication field indicates whether the first target field is used to indicate a TA set; the first signaling is a random access response.

In one embodiment, the slash-filled box is a Timing Advance Command field.

In one embodiment, the cross-filled box is a UL grant field.

In one embodiment, the last two octets (i.e., Oct 6 and Oct 7) in the first signaling include at least the former of the first target field and the first indication field.

In one embodiment, the last two octets in the first signaling include the first target field and the first indication field; the first indication field indicates whether the first target field indicates a TA.

In one subembodiment, a leftmost bit of a first octet in the first signaling is set to 1.

In one subembodiment, that a leftmost bit of a first octet in the first signaling is set to 1 is used to determine that the last two octets in the first signaling are not used for a Temporary C-RNTI field.

In one subembodiment, the slash-filled box corresponds to a TA set, and the first target field in the last two octets in the first signaling corresponds to a TA set.

In one subembodiment, the last two octets in the first signaling include at least one R field.

In one subembodiment, the last two octets in the first signaling do not include any R field.

In one subembodiment, this embodiment does not set a limit on the sizes or locations of the first target field and the first indication field in the last two octets in the first signaling.

In one embodiment, the leftmost bit of a first octet in the first signaling is the first indication field; the last two octets in the first signaling include the first target field; the first indication field indicates whether the first target field indicates a TA.

In one subembodiment, if the first indication field is set to the second value, the first target field is reserved.

In one subembodiment, if the first indication field is set to the second value, the first target field belongs to a Temporary C-RNTI field.

In one subembodiment, if the first indication field is set to the second value, the last two octets in the first signaling is a Temporary C-RNTI field.

In one subembodiment, this embodiment does not set a limit on the size or location of the first target field in the last two octets in the first signaling.

In one embodiment, the leftmost bit of a first octet in the first signaling comprises the first indication field; the last two octets in the first signaling include the first target field; the first indication field indicates whether the first target field indicates a TA set.

In one subembodiment, if the first indication field is set to the second value, the first target field is reserved.

In one subembodiment, if the first indication field is set to the second value, the first target field belongs to a Temporary C-RNTI field.

In one subembodiment, if the first indication field is set to the second value, the last two octets in the first signaling is a Temporary C-RNTI field.

In one subembodiment, this embodiment does not set a limit on the size or location of the first target field in the last two octets in the first signaling.

In one embodiment, this embodiment does not set a limit on the sizes or locations of the first indication field and the first target field of the present application in the first signaling.

### Embodiment 13

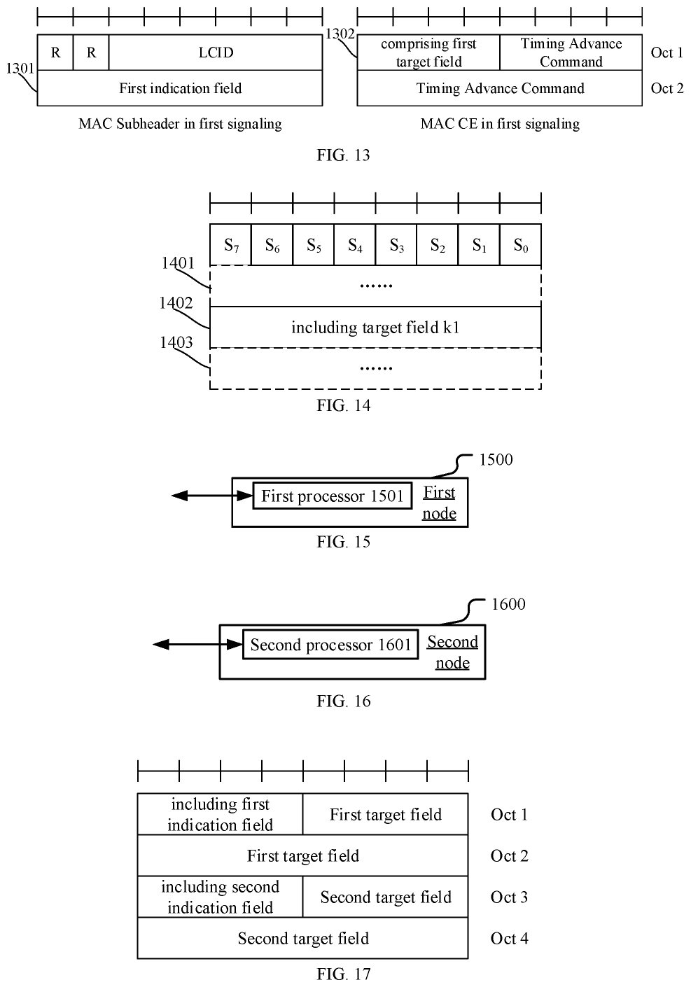

Embodiment 13 illustrates a schematic diagram of the structure of a first signaling according to the fourth embodiment of the present application, as shown in FIG. 13. In FIG. 13, the figure on the left shows a MAC subheader in the first signaling, with the box 1301 being a first indication field; the figure on the right shows a MAC CE in the first signaling, with the box 1302 including a first target field.

In Embodiment 13, the first signaling comprises the first target field and the first indication field; the first indication field indicates whether the first target field is used to indicate a TA set; the first signaling is a MAC subPDU; the first indication field belongs to the MAC subheader in the first signaling, and the first target field belongs to the MAC CE in the first signaling.

In one embodiment, the MAC subheader in the first signaling consists of an LCID field, an eLCID field and 2 R fields.

In one embodiment, the MAC subheader in the first signaling comprises an LCID field, the LCID field being set to 34.

In one embodiment, the MAC CE in the first signaling comprises a Timing Advance Command field.

In one embodiment, the first indication field occupies octet 2 (Oct 2) in the MAC subheader in the first signaling.

In one embodiment, the first indication field is an eLCID field.

In one embodiment, the first target field belongs to the first four bits of octet 1 (Oct 1) in the MAC CE in the first signaling.

In one embodiment, the first target field is located before the Timing Advance Command field.

In one embodiment, there includes at least one bit between the first target field and the Timing Advance Command field.

In one embodiment, there includes not any bit between the first target field and the Timing Advance Command field.

In one embodiment, when the first indication field is set to the first value, the MAC CE in the first signaling is not an Absolute Timing Advance Command MAC CE; when the first indication field is set to the second value, the MAC CE in the first signaling is an Absolute Timing Advance Command MAC CE.

In one embodiment, when the first indication field is set to the first value, the MAC CE in the first signaling is an enhanced Absolute Timing Advance Command MAC CE.

In one embodiment, when the first indication field is set to the first value, the MAC CE in the first signaling is an enhanced Absolute Timing Advance Command MAC CE for m-TRP.

In one embodiment, this embodiment does not set a limit on the sizes or locations of the first indication field and the first target field of the present application in the first signaling.

### Embodiment 14

Embodiment 14 illustrates a schematic diagram of the structure of a first signaling according to the fifth embodiment of the present application, as shown in FIG. 14. In FIG. 14, the S0 corresponds to a TA set 0, while the S1 corresponds to a TA set 1, and so on; the box 1402 marks at least one Octet that includes a target field k1, k1 being an integer no less than 0 and no greater than 7; the dotted-line boxes 1401 and 1403 are octets including other target fields.

In Embodiment 14, the first signaling comprises 8 indication fields and at least 1 target field; each of the 8 indication fields indicates whether a corresponding target field is used to indicate a TA.

In one embodiment, at least one of the dotted-line box 1401 or the dotted-line box 1403 exists.

In one embodiment, neither of the dotted-line box 1401 and the dotted-line box 1403 exists.

In one embodiment, the 8 indication fields respectively correspond to 8 timing advance (TA) sets.

In one embodiment, the 8 indication fields are a bitmap.

In one embodiment, the 8 indication fields are located before the 8 target fields.

In one embodiment, the at least one target field refers to no more than 8 target fields, and size(s) of the at least one target field is(are) variable.

In one subembodiment, if an indication field is set to the first value, there exists a corresponding target field of the indication field; if an indication field is set to the second value, there does not exist a corresponding target field of the indication field.

In one subembodiment, if a corresponding target field of an indication field exists, the indication field indicates that the corresponding target field indicates a TA; if a corresponding target field of an indication field does not exist, the indication field does not indicate that a corresponding target field indicates a TA.

In one subembodiment, the number of the at least one target field is equal to a number of indication field(s) set to the first value among the 8 indication fields.

In one embodiment, the at least one target field refers to 8 target fields, and sizes of the at least one target field are fixed.

In one subembodiment, if an indication field is set to the first value, the indication field indicates that a corresponding target field indicates a TA; if an indication field is set to the second value, the indication field does not indicate that a corresponding target field indicates a TA.

In one embodiment, this embodiment does not set a limit on the size(s) or location(s) of the at least one indication field and the at least one target field of the present application in the first signaling.

### Embodiment 15

Embodiment 15 illustrates a structure block diagram of a processing device used in a first node according to one embodiment of the present application, as shown in FIG. 15. In FIG. 15, a processing device 1500 in the first node comprises a first processor 1501.

The first processor 1501 receives a first signaling, the first signaling comprising at least one indication field and at least one target field.

In Embodiment 15, the first signaling is a signaling at a protocol layer below RRC sublayer; each indication field of the at least one indication field indicates whether a corresponding target field is used for a TA.

In one embodiment, the first processor 1501 receives a first RRC message before the action of receiving a first signaling, the first RRC message comprising configuration information for at least one candidate cell; and applies configuration information for a first cell as a response to the first signaling being received; herein, the at least one candidate cell is configured for at least one serving cell of the first node; the first cell is a candidate cell of the at least one candidate cell; the first signaling is used to indicate the first cell.

In one embodiment, the first processor 1501, after the action of receiving the first RRC message and before the action of receiving a first signaling, transmits a first measurement report; herein, the first measurement report is a signaling at a protocol layer below RRC sublayer.

In one embodiment, the first processor 1501 transmits at least first signal before the action of receiving a first signaling; herein, each signal of the at least first signal is a physical layer signal.

In one embodiment, the first processor 1501 receives a first DCI, the first DCI indicating the at least first signal; herein, each signal of the at least first signal is a PRACH signal; the first DCI is used to trigger a random access procedure which the at least first signal is a part of.

In one embodiment, the first processor 1501, as a response to the action of receiving a first signaling, when each target field in the first signaling indicates a TA, determines that a random access response is received successfully; when at least one target field in the first signaling does not indicate a TA, continues listening over the random access response.

In one embodiment, the first processor 1501, as a response to the action of receiving a first signaling, determines that a random access procedure is successfully completed.

In one embodiment, the first processor 1501, as a response to the action of receiving a first signaling, processes at least one of the at least one target field; herein, the at least one of the at least one target field indicates a TA.

In one embodiment, the first processor 1501 comprises the antenna 452, the receiver 454, the multi-antenna receiving processor 458, the receiving processor 456, the controller/processor 459, the memory 460 and the data source 467 in FIG. 4 of the present application.

In one embodiment, the first processor 1501 comprises the antenna 452, the receiver 454, the multi-antenna receiving processor 458 and the receiving processor 456 in FIG. 4 of the present application.

In one embodiment, the first processor 1501 comprises the antenna 452, the receiver 454 and the receiving processor 456 in FIG. 4 of the present application.

In one embodiment, the first processor 1501 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first processor 1501 comprises the antenna 452, the transmitter 454, the multi-antenna transmitting processor 457 and the transmitting processor 468 in FIG. 4 of the present application.

In one embodiment, the first processor 1501 comprises the antenna 452, the transmitter 454 and the transmitting processor 468 in FIG. 4 of the present application.

### Embodiment 16

Embodiment 16 illustrates a structure block diagram of a processing device used in a second node according to one embodiment of the present application, as shown in FIG. 16. In FIG. 16, a processing device 1600 in the second node comprises a second processor 1601.

The second processor 1601 transmits a first signaling, the first signaling comprising at least one indication field and at least one target field.

In Embodiment 16, the first signaling is a signaling at a protocol layer below RRC sublayer; each indication field of the at least one indication field indicates whether a corresponding target field is used for a TA.

In one embodiment, the second processor 1601 transmits a first RRC message before the action of transmitting a first signaling, the first RRC message comprising configuration information for at least one candidate cell; herein, as a response to the first signaling being received by a receiver of the first signaling, configuration information for a first cell is applied by the receiver of the first signaling; the at least one candidate cell is configured for at least one serving cell of the first node; the first cell is a candidate cell of the at least one candidate cell; the first signaling is used to indicate the first cell.

In one embodiment, the second processor 1601, after the action of transmitting the first RRC message and before the action of transmitting a first signaling, receives a first measurement report; herein, the first measurement report is a signaling at a protocol layer below RRC sublayer.

In one embodiment, the second processor 1601 receives at least first signal before the action of transmitting a first signaling; herein, each signal of the at least first signal is a physical layer signal.

In one embodiment, the second processor 1601 transmits a first DCI, the first DCI indicating the at least first signal; herein, each signal of the at least first signal is a PRACH signal; the first DCI is used to trigger a random access procedure which the at least first signal is a part of.

In one embodiment, as a response to the first signaling being received, when each target field in the first signaling indicates a TA, a random access response is determined to have been received successfully; when at least one target field in the first signaling does not indicate a TA, the random access response continues to be listened over.

In one embodiment, as a response to the first signaling being received, a random access procedure is determined to have been successfully completed.

In one embodiment, as a response to the action of receiving a first signaling, at least one of the at least one target field is processed; herein, the at least one of the at least one target field indicates a TA.

In one embodiment, the second processor 1601 comprises the antenna 420, the transmitter 418, the multi-antenna transmitting processor 471, the transmitting processor 416, the controller/processor 475 and the memory 476 in FIG. 4 of the present application.

In one embodiment, the second processor 1601 comprises the antenna 420, the transmitter 418, the multi-antenna transmitting processor 471 and the transmitting processor 416 in FIG. 4 of the present application.

In one embodiment, the second processor 1601 comprises the antenna 420, the transmitter 418 and the transmitting processor 416 in FIG. 4 of the present application.

In one embodiment, the second processor 1601 comprises the antenna 420, the receiver 418, the multi-antenna receiving processor 472, the receiving processor 470, the controller/processor 475 and the memory 476 in FIG. 4 of the present application.

In one embodiment, the second processor 1601 comprises the antenna 420, the receiver 418, the multi-antenna receiving processor 472 and the receiving processor 470 in FIG. 4 of the present application.

In one embodiment, the second processor 1601 comprises the antenna 420, the receiver 418 and the receiving processor 470 in FIG. 4 of the present application.

### Embodiment 17

Embodiment 17 illustrates a schematic diagram of the structure of a first signaling according to the sixth embodiment of the present application, as shown in FIG. 17.

In Embodiment 17, the first signaling comprises a first indication field, a second indication field, a first target field and a second target field, where the first indication field indicates whether the first target field indicates a TA, and the second indication field indicates whether the second target field indicates a TA; the first signaling is a MAC CE.

In one embodiment, the first indication field and the first target field belong to an Octet 1 (Oct 1) and an Octet 2 (Oct 2), while the second indication field and the second target field belong to an Octet 3 (Oct 3) and an Octet 4 (Oct 4).

In one embodiment, the first indication field and the first target field correspond to a first timing advance (TA) set, while the second indication field and the second target field correspond to a second TA set.

In one embodiment, the first four bits in the Oct 1 include the first indication field; the first four bits in the Oct 3 include the second indication field.

In one embodiment, the first indication field is the leftmost bit in the Oct 1; the second indication field is the leftmost bit in the Oct 3.

In one embodiment, the first indication field is a bit next to the first target field in the Oct 1; the second indication field is a bit next to the second target field in the Oct 3.

In one embodiment, a field other than the first indication field among the first four bits in the Oct 1 indicates a TA set; a field other than the second indication field among the first four bits in the Oct 3 indicates a TA set.

In one embodiment, any field other than the first indication field among the first four bits in the Oct 1 is R field; any field other than the second indication field among the first four bits in the Oct 3 is R field.

In one embodiment, the first four bits in the Oct 1 include R field; the first four bits in the Oct 3 include R field.

In one embodiment, this embodiment does not set a limit on the size or location of any of the first indication field, the second indication field, the first target field and the second target field of the present application in the first signaling.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first processor, receiving a first signaling, the first signaling comprising at least one indication field and at least one target field;
wherein the first signaling is a signaling at a protocol layer below RRC sublayer; each indication field of the at least one indication field indicates whether a corresponding target field is used for a Timing Advance (TA).

2. The first node according to claim 1, characterized in that each indication field of the at least one indication field and a corresponding target field are for a TA set; the TA set is a Timing Advance Group (TAG) to which a candidate cell belongs; the TA refers to: an index value T_{A} used to control the amount of timing adjustment that a MAC entity has to apply.

3. The first node according to claim 1, characterized in that the first signaling is a MAC CE; the first signaling comprises the first indication field, the first target field and the target cell field; the target cell field is used to indicate a candidate cell; the first indication field indicates whether the first target field is used to indicate a TA.

4. The first node according to claim 1, characterized in that each indication field of the at least one indication field occupies multiple consecutive bits; each target field of the at least one target field occupies multiple consecutive bits.

5. The first node according to claim 1, characterized in that the phrase that each indication field of the at least one indication field indicates whether a corresponding target field is used for TA includes: if one indication field of the at least one indication field is set to a first value, the indication field of the at least one indication field indicates that a corresponding target field is used for a TA; if one indication field of the at least one indication field is set to a second value, the indication field of the at least one indication field does not indicate that a corresponding target field is used for a TA; the first value is different from the second value.

6. The first node according to claim 1, characterized in comprising:
the first processor, receiving a first RRC message before the action of receiving a first signaling, the first RRC message comprising configuration information for at least one candidate cell; and applying configuration information for a first cell as a response to the first signaling being received;
wherein the at least one candidate cell is/are configured for at least one serving cell of the first node; the first cell is a candidate cell of the at least one candidate cell; the first signaling is used to indicate the first cell.

7. The first node according to claim 6, characterized in that the at least one serving cell is a first serving cell; the first serving cell is a PSCell, or the first serving cell is a PCell; each candidate cell of the at least one candidate cell is a LTM candidate cell; the first signaling is a LTM command; a field in the first signaling indicates the first cell.

8. The first node according to claim 6, characterized in that the first RRC message comprises a candidate configuration identity for each candidate cell of the at least one candidate cell; the first RRC message comprises a ServingCellConfigCommon IE for each candidate cell of the at least one candidate cell, and/or, the first RRC message comprises a DownlinkConfigCommon IE for each candidate cell of the at least one candidate cell, and/or, the first RRC message comprises an UplinkConfigCommon IE for each candidate cell of the at least one candidate cell, and/or, the first RRC message comprises a ssb-PositionsInBurst field for each candidate cell of the at least one candidate cell.

9. The first node according to claim 6, characterized in comprising:
the first processor, after the action of receiving the first RRC message and before the action of receiving a first signaling, transmitting a first measurement report;
wherein the first measurement report is a signaling at a protocol layer below RRC sublayer.

10. The first node according to claim 9, characterized in that the first measurement report is transmitted through a Physical Uplink Control Channel (PUCCH); the first measurement report indicates at least the first cell; the first measurement report comprises L1 measurement results; the L1 measurement results include L1-RSRP, and/or, the L1 measurement results include L1-RSRQ, and/or, the L1 measurement results include L1-SINR.

11. The first node according to claim 6, characterized in comprising:
the first processor, transmitting at least first signal before the action of receiving a first signaling;
wherein each signal of the at least first signal is a physical layer signal.

12. The first node according to claim 11, characterized in that before the action of receiving a first signaling, the at least first signal is(are) transmitted; each signal of the at least first signal is a Preamble.

13. The first node according to claim 11, characterized in comprising:
the first processor, receiving a first DCI, the first DCI indicating the at least first signal;
wherein each signal of the at least first signal is a PRACH signal; the first DCI is used to trigger a random access procedure which the first signal is a part of.

14. The first node according to claim 13, characterized in that a format of the first DCI is DCI format 1_0; the first DCI comprises at least one field of Identifier for DCI formats, and the field of Identifier for DCI formats is set to 1; the first DCI comprises a Frequency domain resource assignment field, and the Frequency domain resource assignment field is set to all ones.

15. The first node according to claim 13, characterized in that the first DCI is a PDCCH order; the first DCI is identified by a C-RNTI of the first node in the first serving cell; the first DCI comprises a first DCI field, a value of the first DCI field being indexed to the given candidate cell; the first cell is identical to the given candidate cell.

16. The first node according to claim 13, characterized in that the first DCI indicates random access resources of the given candidate cell; the random access resources of the given candidate cell include an index of the first signal; the random access resources of the given candidate cell include an uplink carrier associated with the first signal; the random access resources of the given candidate cell include a PRACH mask associated with the first signal; the random access resources of the given candidate cell include an SSB associated with the first signal.

17. The first node according to claim 1, characterized in comprising:
the first processor, processing at least one of the at least one target field as a response to the action of receiving a first signaling;
wherein the at least one of the at least one target field indicates a TA.

18. A second node for wireless communications, comprising:
a second processor, transmitting a first signaling, the first signaling comprising at least one indication field and at least one target field;
wherein the first signaling is a signaling at a protocol layer below RRC sublayer; each indication field of the at least one indication field indicates whether a corresponding target field is used for a TA.

19. A method in a first node for wireless communications, comprising:
receiving a first signaling, the first signaling comprising at least one indication field and at least one target field;
wherein the first signaling is a signaling at a protocol layer below RRC sublayer; each indication field of the at least one indication field indicates whether a corresponding target field is used for a TA.

20. A method in a second node for wireless communications, comprising:
transmitting a first signaling, the first signaling comprising at least one indication field and at least one target field;
wherein the first signaling is a signaling at a protocol layer below RRC sublayer; each indication field of the at least one indication field indicates whether a corresponding target field is used for a TA.
